(19) United States
(12) Patent Application Publication
(10) Pub. No.: US 2008/0114608 A1
(43) Pub. Date: May 15, 2008

(54) System and method for rating performance

(76) Inventor: Rene Bastien, Beaconsfield (CA)

Correspondence Address: OGILVY RENAULT LLP, 1981 MCGILL COLLEGE AVENUE, SUITE 1600, MONTREAL, QC, H3A2Y3, omitted

(21) Appl. No.: 11/595,929

(22) Filed: Nov. 13, 2006

(51) Int. Cl. G06Q 99/00

(52) U.S. Cl. 705/1

(57) ABSTRACT

A method and apparatus are disclosed for generating a rating scale to be used in an evaluation form, the rating scale comprising a plurality of rating levels, each comprising at least one element to rate and a plurality of qualifying quantifiers, associating at least one of the qualifying quantifiers to each of the elements to rate.

### FIELD OF THE INVENTION

The present invention relates to an improved performance evaluation system. More particularly, the present invention relates to a new rating scale and a system to produce performance evaluations.

### BACKGROUND OF THE INVENTION

Being for business, economics, management, scientific or other purposes, many fields of the human activities need to measure performances accurately and reliably. One of the most important types of performances relates to employee performance at work. Indeed, with the exception of small organizations, most companies, in North America especially, use an employee performance evaluation system, hereafter called “performance evaluation system”. The broad utilization of performance evaluation systems reflects on the utility of such systems. Systems and methods were developed over the years, as evaluation tools were needed to assist in measuring and judging employee performance. Typically, employee performance ratings for either medium or large organizations are criticized or simply rejected. In practice, the failure to perform accurate and reliable performance ratings is one of the primary causes of the fairly common failure of performance evaluation systems [Armstrong 1999:41] and [Cardy 1994:2].

Prior art methods exist that are used for rating the performance of employees and all of them have major drawbacks. A brief description of prior art rating scales drawbacks follows. The Mixed Standard Scale is found to be difficult and expensive to develop. In terms of level of leniency or halo, it shows no advantage over other rating methods. A leniency error refers to a rating error that occurs when a person evaluating, hereafter called “rater”, has a tendency to steer away from assigning average and lower ratings. The halo error is perhaps the most common rater error. It refers to a rating error that occurs when a rater gives favorable ratings to all job factors based on impressive performance in just one job factor. Raters do not like the Mixed Standard Scale format because they resent not being able to directly assign performance ratings [Cardy 1994:77-79]. In addition, it does not allow self-monitoring by the employee.

Constructing a Forced-Choice Rating Scale requires professional psychometric expertise. It is also found to be time consuming and very expensive. Implementing such format also sends a strong message to supervisors that they cannot be trusted, and in reaction raters despise using this format [Cardy 1994:80-81]. In addition, it does not allow self-monitoring by the employee [Latham 1994:78].

Regarding the Graphic Rating Scale, the major criticism leveled at them is that their anchors are ambiguous and not defined in behavioral terms. For example, as a rater goes through each job factor, he will attribute different meanings to anchors to account for a specific job dimension. A consequence of this ambiguity is that it is difficult to compare the meaning of ratings across raters and the persons to evaluate, hereafter called “ratees”. Similarly, raters and their employees may have different interpretations of anchors. The major limitation of this rating method lies with its ambiguity and the extent to which such ambiguity may result in inflation of ratings (leniency) [Cardy 1994:69-72].

Even if the rationale of Smith and Kendall in 1963 when they introduced the Behaviorally Anchored Rating Scale, also known as Behaviorally Expectation Scale, was to remove the ambiguity associated with the Graphic Rating Scale, way too much ambiguity remains. Firstly, because too few anchors are used along the scale in order to clarify the meaning of effective or ineffective performance. Secondly, as Cardy [1994:74] wrote “the ratee does not have to actually exhibit the behaviors on the scale. Instead, the behaviors are used only as a guide to help the rater understand the level of performance that is required before a ratee can be assigned high, average, or low performance ratings”. However, Armstrong [1999:40] wrote “ . . . there is still room for making very subjective judgments based on different interpretations of the definitions of levels of behavior.” On the other hand, to avoid ambiguity, scale anchors could be made very specific. Nevertheless, other problems arise when anchors are too specific. For example, if the ratee performance level does not correspond sufficiently to anyone of the scale anchors because they are too specific, it is difficult to use them as a guide for rating performance. To address such cases, Borman has used anchors representing a wider range of behaviors and named the scale the Behavioral Summary Scale. Cardy [1994:74] reported the results of a review of several studies published in 1984 by Bemardin and Beatty regarding the quality of ratings with Behaviorally Anchored Rating Scales “Several studies have compared the leniency of Behaviorally Anchored Rating Scales with that of other formats. The general conclusion that emerges from this research is that leniency is equally prevalent with all rating formats”.

The two main differences between Borman's Behavioral Summary Scale [Borman 1986:106-107] and a Behaviorally Anchored Rating Scale are that the former comprises more low-base rate behaviors then the later and it defines its behavioral anchors even less specifically than the later. The operations to rate a performance are the same as for Behaviorally Anchored Rating Scales. The rater needs to record as many behavioral examples and to compare them to the scale behavioral statements or anchors. Such recording and comparing operations are very time consuming and inefficient. More importantly, Borman [1986:115] concluded that “in the one format comparison study pitting Behaviorally Anchored Rating Scale against a Behavioral Summary Scale format, there were no consistent differences between these format types with respect to psychometric error or accuracy”.

The purpose for which the Behaviorally Observation Scale [Latham 1994:85] was developed is to assist counseling and developing employees. With a Behaviorally Observation Scale, emphasis is placed on developing an inventory of behaviors, rating employees with a Likert scale on the frequency with which they demonstrate each behavior. Several problems arise from this method. A major drawback to this rating method is that the frequency rating scale is too ambiguous. Using a five-point frequency scale is not truly a ratio scale in practice. It is not realistic to require a rater to be held accountable for ascertaining whether a person literally did something 95 percent of the time versus 92 percent of the time. The degree to which raters can distinguish between 0-64 percent of the time, 75-84 percent of the time, and the like is very questionable. Judgment obviously affects these ratings. A consequence of the ambiguity of the frequency scale and of the behaviors statements will result, as with Behaviorally Anchored Rating Scales and Graphic Rating Scales, with leniency and halo. To address this problem, rater training is strongly recommended in observing and recording job behaviors [Latham 1994:90]. Latham [1994:96] also reported the criticism published in 1982 by Kane and Bernardin who “ . . . have argued that this is not a tenable practice. For example, in a police detective's job a 74-85 percent occurrence rate may constitute superior performance in obtaining arrest warrants within three months in homicide cases but abysmal performance in being vindicated by the internal review board in instances of having used lethal force.” To address this problem, Latham [1994:96] suggested not to rate each behavior on the same basis, the frequency with which a behavior must be exhibited to get a numerical rating of 0-4 can be determined by the user. In practice, doing this will simply confused raters, as they would need to keep track of the differences between each frequency scale about the meaning of their respective intervals. In addition, if using a large inventory of behaviors meets the purpose of the method, which is to develop employees, evaluating those behaviors becomes very time consuming.

Causes of prior art rating scales drawbacks and consequent failures of performance evaluation systems can be categorized into four categories, problems related to psychometric capabilities, to qualitative capabilities, to their costs to the organization and to their quality control.

Regarding rating scales psychometric capabilities, a tremendous amount of research and practice of the primary causes and key dimensions of prior art major drawbacks exist that are pursued to improve prior art rating methods. The psychometric capabilities of rating scales determine their appropriateness to measure employee performance with regard to the degree of validity, of ratings errors and of rating accuracy.

Regarding content validity, most of the time, the same job dimensions and the same performance standards are used to evaluate the performance of a large body of employees with widely different tasks and responsibilities. For example, the same evaluation form, with or without minor variations, is often used to appraise the performance of all employees. Poor content validity of job factors and/or performance standards is an extremely common manifestation of the too large costs associated with designing, creating, maintaining and managing content valid job factors and/or performance standards that are specific to a category of jobs or to individual jobs. Latham [1994:71] also wrote “ . . . in attempting to be practical, organizations are often very impractical in trying to develop a simple, easily administrated appraisal system based on traits that can be used for all employees”. Because [Latham 1994:50] “ . . . a trait-oriented appraisal instrument is likely to be frowned on by the courts because traits are so vague”.

Robert [1998:309] wrote, “A tremendous amount of research and practice focuses on reducing rating errors including leniency, halo and recency effects, among others”. Hauenstein [1998:414-415] wrote “The most frequently discussed rater biases are related to the failure to differentiate among ratees, and fall into two classes commonly known as leniency error and halo error”. No rating method facilitates sufficiently raters in differentiating among ratees. Rating errors reduce the validity, reliability and utility of performance evaluation systems. The most common approach to address rating errors involves a comprehensive rater-training program. Rater error training is predicated the assumption that raters possess certain biases that decrease rating accuracy. Hauenstein also reported the result of a review of rater training research published by Woehr and Huffcutt (1994) where they “indicated that RET (rater error training) was modestly effective in reducing halo and leniency”.

Research and practice also focus on improving rating accuracy. Landy [1983:22-23] wrote, “One can conceive a set of ratings that are reliable and that are valid, but that are inaccurate due to a severe or lenient rater. [ . . . ] Such an inaccuracy would affect the cutting score that we might set to establish an eligibility list for selection, however, and for that purpose the inaccuracy would be important”. Cardy [1994:48] also wrote, “A fundamental commonality among all accuracy measures is the requirement of a standard against which judgments can be compared. Sometimes, such standards are clearly self-evident and obvious. For example, athletic competitions involving distance thrown, height jumped, number of bull's-eyes shot, and so on, all have criteria that are clear and present in the external environment. Little judgment is required to assess the level of performance in such situations. Unfortunately, clear and objective standards are seldom available when appraising work performance in organizations. Performance is typically assessed on a subjective basis and without the aid of precise external and quantifiable standards. Without such standards, the accuracy of performance judgments is virtually impossible to assess”. Thus, prior art rating scales lacking the aid of precise external and quantifiable standards have not well performed concerning rating comparability.

Some research of key directions to address prior art psychometric capability drawbacks exist that are pursued to improve prior art rating methods, for example by increasing the sources of ratings.

Since employees probably always make self-ratings, formalizing the self-rating process offers a way of identifying major discrepancies between self and supervisor ratings. Bemardin [1989:240] wrote “Thus, for the most part, a procedure that reduces the discrepancy in self versus supervisory evaluation [ . . . ] should contribute to agreement on and attainment of performance goals for the future”. The primary roadblock preventing self-ratings from being widely used is that they are extremely lenient. Ambiguous scale anchors promote inflation in self-ratings. They allow raters to interpret a performance standard in any way that they wish. This allows ratees to assign highly inflated self-ratings. Consequently, self-ratings also fail to converge with supervisors ratings.

Peer ratings would appear to be a very valuable source of job performance information. “Peers are often in a better position to evaluate job performance than are supervisors. But there is several problems that may interfere with user acceptability. First, peer ratings may be perceived as a popularity contest. Second, they may be perceived to be biased by friendship and the similarity between rater and ratee. Finally, they provide employees with the opportunity to alter their valuations of others in order to enhance their own outcomes” [Cardy 1994:157-158].

Multi-raters or 360-degree appraisal systems involve, at least, two sources, including one-self, and the supervisor, peers, subordinates, customers or suppliers. Smither [2005:60] wrote “ . . . that it is unrealistic for practitioners to expect large across-the-board performance improvement after people receive multi-source feedback”. An important drawback of these systems is their cost due to the need for an industrial psychologist to aggregate the results of the evaluations and to manage rating errors resulting from numerous subjective evaluations performed by the raters involved.

Now regarding the second category of causes, rating scales qualitative capabilities, many are dependent on rating scales psychometric capabilities. The qualitative capabilities of rating scales determine their appropriateness to set individual goals, to monitor performance and coach employees, to evaluate employees, to continuously improve employee performances, and to adapt standards to the environment of business. They also determine the degree of acceptance of a rating scale by its users. A tremendous amount of research and practice focuses on rating scales qualitative capabilities and more specifically on performance standards acceptance and goal setting, and heartburn.

One major rating scale qualitative capability problem relates to performance standards acceptance and goal setting. Goal setting is among supervisors' most difficult and time-consuming tasks. Because they are unable to judge adequately what is the current level of performance of their employees, they have an even more difficult time to establish what would be difficult, while achievable, individual goals. In addition, while employees understand the notion of performance improvement, rarely supervisors will express goals in such terms. In fact, Armstrong [1999:67] stated, “Managers might find it difficult to answer the question “What do I have to do get a higher rating?”” Prior art rating scales is not suited to motivate employees through goal setting processes because performance standards are too vague, inappropriate in terms of goal difficulty, and either too hard or too easily achieved.

Another major problem raised by Cardy [1994:56] relates to the degree of uncomfortableness or “heartburn”, experienced by raters and ratees. Roberts [1998:307] wrote “A very serious and common problem in performance appraisal is the inability or unwillingness to provide negative feedback. Clearly, many managers avoid providing negative feedback for a variety of reasons including fear of the consequent conflict, a deterioration of supervisory-employee relations, and lack of confidence in the accuracy of the rating instrument”. Cardy also wrote, “An appraisal discomfort measure could have obvious applied value. Techniques that effectively reduced such discomfort could provide meaningful improvement to the daily lives of managers. Further, reduction in appraisal related discomfort could improve the evaluation of ratees. Manager could focus on accurate assessment of ratee performance rather than anticipating the heartburn they will experience if an accurate assessment is made”. Cardy continued with “On the ratee side, discomfort regarding appraisal could be due to the nature of the appraisal experience, the rater, or the ambiguity and unfairness in the performance standards, among other factors. Decreasing ratee fear and discomfort regarding appraisal could provide not only psychological benefit but also the setting for motivated and improved performance”.

Concerning costs incurred by using ratings scales, they consist mainly into managers' time and opportunity costs, e.g. under-realizing sales, productivity, asset utilization and cost reductions. Managers, as raters, are by far the primary users of a performance evaluation system. For many of them, preparing, conducting and documenting formal performance reviews requires a great amount of time. An even greater amount of time is also required to plan, devise, document and communicate individual improvement goals such that each employee perceives his as difficult enough so he feels challenged but achievable to remain motivated to accomplish them. In addition, in most organizations formal reviews take place at the end of the fiscal year of the organization. This is in addition to another demanding task, the budgeting process. All this additional workload coincides in time while managers have to continue taking care of regular business. It is easy to understand how managers are pressured for time and how important it is to provide them with a performance evaluation system that enables them to be efficient in evaluating as in establishing goals for their employees. However, prior art rating scales do not provide such efficiency. The high degree of anchor ambiguity makes it very difficult to rapidly judge performance with little cognitive efforts and it contributes to rating errors. It is a source of heartburn and procrastination and it does not aid managers to establish for each employee personalized behavioral goals, for example. As consequences, there is currently a managerial substantial cost to perform “good” evaluations and establish “good” goals. On another hand, those who do not take the necessary time contribute to jeopardize the whole evaluation process by lowering the quality of evaluations and by not motivating their group. This leads employees to repudiate the evaluation results, the feedback received and the performance evaluation system itself. Such consequences have a considerable opportunity cost to an organization. Either way, current performance evaluation systems built based on prior art rating scales bare a significant cost to organizations.

With regards to the quality control of ratings, i.e. to assess how well supervisors rate their employees, their absence can lead to the failure of the evaluation process. Many organizations, as part of their evaluation process, have each supervisor's manager review and authorize the evaluations produced. In still many organizations, the Human Resources Department must also authorize employees' evaluations. These controls add to the cost of performance evaluation systems but do nothing to the quality of ratings. Firstly, supervisors' managers are often to far away from employees being evaluated. They have not observed the employees at work and they are not in a position to judge the appropriateness of the ratings they received, neither the Human Resources Department. Their role as more to do with ensuring that company policies are respected, e.g. avoiding discriminatory comments, applying a forced distribution, or that special cases, like employee terminations, are handled following company procedures. By not controlling the quality of ratings per se, like for any other unmeasured human activity, it opens the door to errors. It also leads to incorrectly understanding rating scales content or their usage, and to developing counter productive habits. Still, it also leads to poor discrimination of performances, unfair evaluations, and it contributes to jeopardizing the whole evaluation process. As a result, employees repudiate their evaluation results, the feedback received and the performance evaluation system itself. Not controlling the quality of ratings results in considerable opportunity costs to an organization.

Still with regards to the quality control of ratings, their absence combined to prior art rating scales ambiguous performance standards can lead to undesirable legal liabilities. Malos [1998:49] wrote “To say that the importance of legal issues in performance appraisal has skyrocketed in recent years would be something of an understatement.” He [1998:60] also wrote “Performance appraisals figure less prominently in disparate impact cases, in which a seemingly neutral employment practice may have an unintentional but nonetheless discriminatory effect. In such cases, employees must demonstrate a causal connection between a specific employment practice, for example, performance appraisals, and a discriminatory result, [ . . . ]. Appraisal results can then be used [by employer] to rebut plaintiffs', usually statistical, evidence of an improper disparity in promotion, layoff, or other employment decisions. [ . . . ] the employer must show that the challenged practice bears a “manifest relationship” to job performance consistent with “business necessity”. [ . . . ]. The employee then may establish pretext if he or she can show that other appraisal practices would have served the employer's interests without such a discriminatory effect (Albemarle Paper Co. v. Moody, 422 U.S. 405 [1975])”. Along the same line, Latham [1994:38] wrote, “The court now requires the employee to show that there is an alternative employment practice that equally serves the employer's interest in productivity. The employer then must subsequently refuse to use it before the employee can win a charge of employment discrimination.”

In the United-States, an employer may be exposed to complaints alleging discrimination being filed with both the Office of Federal Contract Compliance Programs (OFCCP) and the Equal Employment Opportunity Commission (EEOC). Thus, an employer can be required to conduct defense with more than one agency at the same time. The costs, e.g. lawyer, court, and other legal fees, in addition to compensatory and punitive damages, reinstatement, back pay, etc, involved with such procedures can be enormous. Malos wrote [1998:92] “ . . . both subjective performance standards and raters biases can spawn discrimination claims and are difficult to defend.” Organizations should control the quality of ratings to ensure that managers avoid rating errors like the one mentioned by Malos [1998:92] “central tendency or “friendliness” errors that can make subsequent demotions or discharges difficult to defend”. Regarding a safe way for organizations to use a performance appraisal system, Clifford [1999:122] wrote “provided you follow the criteria for evaluation systems laid down by the Uniform Guidelines [issued by EEOC for Title VII compliance]” and that “You must be able to prove that there is no other means of evaluating employee performance that would be less discriminatory.” Among prior art rating scales, none stands out enough by having significantly less subjective performance standards and/or by enabling some degree of rating quality control, such that they be preferably put to use by organizations to reduce their legal liability risk.

Because of prior art rating scale drawbacks and problems, there is a need for an improved rating scale method and system to evaluate employees' performances.

### SUMMARY OF THE INVENTION

The present invention overcomes the above referenced shortcomings of the prior art rating scales by providing an electronic system in which a new rating scale format and method, hereafter called “Step Rating Scale”, is used firstly to efficiently differentiate performances while significantly reducing rating errors and improving rating accuracy. The Step Rating Scale can be applied to a wide range of applications to measure qualitative or quantitative phenomena. The invention is disclosed through a performance evaluation system as exemplary embodiment where phenomena consist in employee performances.

The Step Rating Scale method assumes that phenomena to measure are observable. Observations may be of quantitative or qualitative nature.

For the purpose of the present invention, a specific observation of a phenomenon is expressed in terms of “level of phenomenon observed”. In the exemplary embodiment, there is a phenomenon called “Decision Making Skills” 820. An observation of the phenomenon may be expressed as the “level of decision making skills observed”. In another case, the phenomenon may be the sales amount of the Eastern Division of a company. In such case, the phenomenon may be expressed as the “level of sales dollars observed”, i.e. reported by sales reports. To simplifying the text, any observation of any phenomena will be expressed as the Level of Performance Observed (LPO), where the term “Performance” stands for the phenomenon itself.

The purpose of the Step Rating Scale is to measure the levels of performance observed “sufficiently accurately” to differentiate among them.

The words behavior and competence are often interchangeable. For example, if we define the word “behavior” as to act in a particular way, the word “act” as to take action or do something, the word “competence” as the quality of being competent, the word “competent” as having skills or knowledge to do something, and the word “skill” as a particular ability or dexterity to do something well. Therefore, by deduction, with a competence involving a skill, the definition of the word “competence” may be restated as a particular behavior to do something well. Where a competence corresponds to a particular knowledge, hereafter called a “knowledge-based competence”, the interchangeability does not apply and either the term competence or knowledge-based competence may be used. For the purpose of the present invention, a behavior may be either a cognitive or a physical act.

A Step Rating Scale has the following structure. The scale is made of a series of sequential descriptive constructed statements. Each one is called a “Standardized Level of Performance”, hereafter called “SLP”. Bokko [1994:7] wrote, “Performance standards that are clear, descriptive, and specific, and consequently allow for feedback along these dimensions, should produce more desirable responses.” A Standardized Level of Performance describes a very specific level of performance of the phenomena to measure. So specific that to recognize its level of performance requires little judgment. The scale may be created using any media that can be read, e.g. paper media, electronic media, etc. For convenience, Standardized Levels of Performance can be laid-out vertically but they may as well be laid-out horizontally. Still for convenience, with vertically laid-out Standardized Levels of Performance, the top and bottom Standardized Levels of Performance describe respectively the Highest Standardized Level of Performance of the scale, hereafter called “HSLP”, and the “Lowest Standardized Level of Performance” of the scale, hereafter called “LSLP”. With horizontally laid-out Standardized Levels of Performance, the left and right Standardized Levels of Performance could describe respectively the Highest Standardized Level of Performance and the Lowest Standardized Level of Performance. Any intermediary Standardized Levels of Performance is located between the Highest Standardized Level of Performance and the Lowest Standardized Level of Performance, in order of increasing levels of performance, from the Lowest Standardized Level of Performance to the Highest Standardized Level of Performance. The following example illustrates the structure of a Step Rating Scale where the increment “i” varies from one to a value “p” greater or equal to two. The parameter “p” is the number of Standardized Levels of Performance (SLP) in the Step Rating Scale.

SLP₍ₚ₎ or HSLP
SLP₍ₚ₋₁₎
...
SLP₍₁₎ or LSLP

A first characteristic of the Step Rating Scale format consists to its variable number of Standardized Levels of Performance from a minimum of two. A second characteristic regards the differential in performance level between any two consecutive Standardized Levels of Performance. It can vary.

A Standardized Level of Performance has the following structure. It is made of one or more descriptive constructed statements. Each one is called a Standardized Norm of Performance, hereafter called “SNP”. A Standardized Norm of Performance describes a specific level of performance of an important behavioral dimension, hereafter called “critical incident”, of a job factor. Such critical incidents may be determined by doing a job analysis with the Critical Incident Technique [Latham 1994:61]. The description of the level of performance is so specific that to recognize it requires a negligible effort of judgment. The format of a Standardized Level of Performance may be represented mathematically by a construction of Standardized Norms of Performance assembled with Boolean operators. The “AND” Boolean operators may be used to increase the specificity of a Standardized Level of Performance. The following table illustrates the structure of some Standardized Levels of Performance where the parameter “p” is the total number of Standardized Levels of Performance in a Step Rating Scale and the parameter “n” is the maximum number of Standardized Norms of Performance per Standardized Level of Performance.

| | |
|---|---|
| SLP₍ₚ₎ | = SNP_{(p,1)} AND ... AND SNP_{(p,,n-1)} AND SNP_{(p,n)} |
| SLP₍ₚ₋₁₎ | = SNP_{(p-1,1)} AND ... AND SNP_{(p-1,,n-1)} AND SNP_{(p-1,n)} |

...
SLP₍₁₎ = SNP_{(1,1)} AND ... AND SNP_{(1,,n-1)} AND SNP_{(1,n)}

A Standardized Norm of Performance is constructed from two components, the first one is an external, i.e. observable, component and the second one is a quantifiable component. The first component is a “text expression” which describes a specific “Critical Incident” of the phenomenon to measure. A Critical Incident frequently represents a text expression describing a performance of qualitative nature, e.g. behavior, skill, competence. For example, in the exemplary embodiment with the Decision Making Skills job factor, an example of a Critical Incident (CI) may be “Understands the implications of situations” or, less frequently, for the purpose of the present invention, it can represent a text expression stating the unit of measure in cases of performances of quantitative nature, e.g. dollars, percent, date, etc. In cases of performances of qualitative nature, e.g. behaviors, skills, competencies, the second Standardized Norm of Performance component may be a quantitative qualifier text expression, hereafter called a “quantifier” or “Q”, e.g. “Always”, “Usually”, “Rarely”. Still for the purpose of the present invention, in cases of performances of quantitative nature, e.g. amount of sales in the Eastern Division, the second Standardized Norm of Performance component may be a numerical value. Such 2-component structure enables a Standardized Norm of Performance to describe a clear and specific level of performance of the phenomenon to measure. So specific that to recognize its level of performance requires a negligible cognitive effort. The format of a Standardized Norm of Performance may be represented mathematically by a combination “QCI_{(q)(n)}” where the parameter “q” represents the maximum number of quantifiers that may be combined with a specific Critical Incident. The parameter “n” is the maximum number of Critical Incidents per Standardized Level of Performance, i.e., the maximum number of Standardized Norms of Performance per Standardized Level of Performance. In this example, “q” equals three and “n” equals one.

### Q_{(q)}=Q_{(q=3)}=“Always”

### Q_{(q-1)}=Q_{(q=2)}=“Usually”

### Q_{(q-2)}=Q_{(q=1)}=“Rarely”

### CI₍ₙ₌₁₎=“Understands the implications of situations”

### QCI_{(q=3)(n=1)}=“Always understands the implications of situations”

### QCI_{(q=2)(n=1)}=“Usually understands the implications of situations”

### QCI_{(q=1)(n=1)}=“Rarely understands the implications of situations”

The syntax of a combination QCI is phenomenon and language dependent. For example, in the English language, the syntax of a combination QCI to describe a behavior-based competence 820 will be different from the one to describe a knowledge-based competence 900. A third characteristic of the Step Rating Scale consists to its versatility to be used to measure any quantitative or qualitative phenomenon.

For the purpose of the present invention, in cases of performances of qualitative nature a formal quantifier text expression may be absent from the combination QCI. In such cases, the quantifier is assumed to be “Always”, if the Critical Incident text expression is an affirmatively formulated statement, or “Never”, if the Critical Incident text expression is a negatively formulated statement. For example, the Standardized Norm of Performance text expression “Understands the implications of situations” is equal to the QCI text expression “Always understands the implications of situations”. As well, the Standardized Norm of Performance text expression “Does not understand the implications of situations” is equal to the QCI text expression “Never understands the implications of situations”.

For the purpose of the present invention, a Step Rating Scale may present the following Standardized Levels of Performance alternatives. It may either have absolute, i.e. bounded, or relative, i.e. unbounded, Highest Standardized Level of Performance and/or Lowest Standardized Level of Performance. If either or both describe(s) an absolute level of performance, the scale is said to be bounded at that end. On the contrary, if either or both describe(s) a relative level of performance, the scale is said to be unbounded at that end. For example, to account for any Level of Performance Observed that can fall below an absolute Lowest Standardized Level of Performance, a relative Lowest Standardized Level of Performance could be used. It could read, “The level of performance observed is below the previous standardized level of performance.” As well, to account for any Level of Performance Observed that can fall above an absolute Highest Standardized Level of Performance, a relative Highest Standardized Level of Performance could be used. It could read, “The level of performance observed is higher than the following standardized level of performance”. A fourth characteristic of the Step Rating Scale is that it can be designed to cover any range of performance to measure.

For the purpose of the present invention, a Step Rating Scale may be graded with a numerical value assigned to each Standardized Level of Performance such that the “numerical value set” and the “Standardized Levels of Performance set” relation describes a mathematical function. I.e. for each element of its departure set (Standardized Levels of Performance set), the Step Rating Scale associates at most one image, i.e. one numerical value. The following example illustrates a Step Rating Scale where the parameter “p” represents the number of Standardized Levels of Performance in the scale and where the numerical values “p”, “p−1”, down to “1”, are assigned to each Standardized Level of Performance in the relation. A fifth characteristic of the Step Rating Scale consists to the mathematical function it can establish between Standardized Levels of Performance and a numerical counterpart.

| Image | Departure set |
|---|---|
| P | SLP₍ₚ₎ |
| p − 1 | SLP₍ₚ₋₁₎ |
| . . . | . . . |
| 1 | SLP₍₁₎ |

For the purpose of the present invention, it is assumed a rater has determined the Level of Performance Observed of the performance to rate. A rater may have determined the ratee Level of Performance Observed by having gathered sufficient valid observations of his performance. Still for the purpose of the present invention, the method to rate a performance with a Step Rating Scale requires following two simple yet mandatory rules:

### Rule 1: Start at the Highest Standardized Level of Performance.

Rule 2: Compare the Level of Performance Observed to the Standardized Level of Performance. If the Level of Performance Observed is equal to or greater than the Standardized Level of Performance, rate the Level of Performance Observed at that level. On the contrary, move one level down to the next Standardized Level of Performance and repeat Rule 2.

A sixth characteristic of the Step Rating Scale consists to its very specific and constraining rules to rate performances. A seventh characteristic of the Step Rating Scale consists to being able to describe it by a mathematical model called a “Step Function”. A first property of the Step Rating Scale is that any Level of Performance Observed either equal a Standardized Level of Performance or falls between two consecutive Standardized Levels of Performance. This statement assumes an unbounded Step Rating Scale. With a bounded or partially bounded Step Rating Scale, the first property always applies inside the Lowest Standardized Level of Performance-Highest Standardized Level of Performance range.

The differential between any two consecutive SLP₍ᵢ₎ and SLP₍ᵢ₊₁₎, where SLP₍ᵢ₊₁₎ is greater than SLP₍ᵢ₎, is called the “Standardized Rating Error” or “SRE”. Specific Standardized Rating Errors are defined by the following formula:

SRE_{(i+1, i)}=SLP₍ᵢ₊₁₎−SLP₍ᵢ₎

Because of the Step Rating Scale rating method Rule 2, when a rater judges a Level of Performance Observed to be between two consecutive SLP₍ᵢ₎ and SLP₍ᵢ₊₁₎, where SLP₍ᵢ₊₁₎ is greater than SLP₍ᵢ₎, the Step Rating Scale constrains the rater to make a rating error. That rating error is equal to the difference between the Level of Performance Observed and the next SLP₍ᵢ₎, where the Level of Performance Observed is greater than SLP₍ᵢ₎. Such rating error is called the “Induced Rating Error” or “IRE” and it is defined by the following formula:

IRE_{(LPO, i)}=LPO−SLP₍ᵢ₎

The IRE_{(LPO, i)} is the mathematical expression of “a sufficiently accurate rating” for a given Level of Performance Observed, as introduced in the Step Rating Scale purpose statement. A second property of the Step Rating Scale is that for any Level of Performance Observed located between any two consecutive SLP₍ᵢ₎ and SLP₍ᵢ₊₁₎. IRE_{(LPO, i)} is always smaller than SRE_{(i+1, i)}.

How many Standardized Norms of Performance should be included in a Standardized Level of Performance? While no exact procedure provides the answer to this question, for content validity purpose, the key Critical Incidents or a subset of the most important ones should be used to build Standardized Norms of Performance. Latham [1994:97] wrote “As Bernardin, Morgan, and Winne (1980) stated, content validity is concerned with the degree to which the rating scale items are a representative sample of all important items that could have been included in the scale. Thus the scale does not have to comprise every single important item.” While more Standardized Norms of Performance does not necessarily mean longer rater reading time, e.g. if only one quantifier is not satisfied, there is no need to read the rest of the Standardized Level of Performance, it certainly adds constraints to Standardized Levels of Performance, thereby diminishing the cognitive effort required to judge a Level of Performance Observed and greatly reducing rating time. Therefore, content validity and rating efficiency are important concerns when designing Standardized Norms of Performance.

Similarly, how many Standardized Levels of Performance should be included in a Step Rating Scale? Again, no exact procedure provides the answer to that question but for performance differentiation purposes, enough Standardized Levels of Performance should make the scale to satisfy the level of performance differentiation desired. The differentiation of Standardized Levels of Performance is mainly obtained from the incremental degrees of performance expressed by the different quantifiers, for a Standardized Norm of Performance, or by the different combinations of Standardized Norms of Performance, for a Standardized Level of Performance. The ability to set individual goals that are difficult yet achievable requires that there is at least one or more Standardized Levels of Performance above any Level of Performance Observed rated. The first Standardized Level of Performance above the Level of Performance Observed is a logical candidate for a goal. By being the very next level of performance on the scale, such incremental goal can be qualified as achievable or the most achievable. But the first Standardized Level of Performance above the Level of Performance Observed may not be difficult enough to be challenging. This is a case where more than a single Standardized Level of Performance above any Level of Performance Observed rated would be preferred. Therefore, differentiating performances and efficiently establishing difficult yet achievable goals are important concerns when designing a Step Rating Scale.

When the desired level of performance differentiation is not satisfied or when Standardized Levels of Performance are not present to establish difficult yet achievable goals, a Step Rating Scale must then be calibrated. The calibration process consists firstly to add, modify and/or delete Standardized Norms of Performance such that Standardized Levels of Performance are more or less constrained. Secondly, it consists to add, modify and/or delete Standardized Levels of Performance such that the scale is more or less expanded. Such actions are usually targeted at a specific range of Standardized Levels of Performance. For example, in mathematical terms, the Step Rating Scale designer may calibrate the scale to improve Levels of Performances Observed differentiation by adding a SLP₍ₖ₎ between two consecutive SLP₍ᵢ₎ and SLP₍ᵢ₊₁₎, where SLP₍ᵢ₊₁₎ is greater than SLP₍ᵢ₎, such that for a Level of Performance Observed:

SRE_{(k, i)}<IRE_{(LPO, i)}<SRE_{(i+1, i)}.

Because the IRE_{(LPO,i)} is greater than SRE_{(k,i)}, the Level of Performance Observed will be attributed a new image, the image of SLP₍ₖ₎, i.e., the numerical value assigned to it. Its Induced Rating Error will become IRE_{(LPO,k)} where:

IRE_{(LPO, k)}<IRE_{(LPO, i)}.

Once calibrated, an eight characteristic of a Step Rating Scale is that its Standardized Levels of Performance are organized in performance improvement levels. A third property of the Step Rating Scale is that its calibration is satisfactory when its set of Standardized Rating Errors enables to differentiate a set of Levels of Performances Observed. A corollary to the third property is that a calibrated Step Rating Scale will produce “sufficiently accurate” ratings. Landy [1983:23] wrote, “We need to create innovative ways of studying accuracy in realistic settings. We must also be sensitive to the fact that accuracy is dependent on the intended use of the information. Only inaccuracies that change a personnel decision, either on the part of the organization or of the individual, are really important”. Thus, even if the Step Rating Scale rating method induces relatively small rating errors, the second property of the Step Rating Scale tells us that those Induced Rating Errors are not sufficiently important to change the result pursued, the differentiation of performances.

Bokko [1994:5] wrote, “In order for external standards to have a positive influence on motivation through goal-setting process, externally defined standards must be translated by the individual into personal goals that are specific and difficult.” A Step Rating Scale based performance evaluation system may automatically propose to its user a difficult yet achievable goal. Bokko [1994:9] also wrote “ . . . expectations should be realistically difficult, where the realistic level is based on ability.” Along this line, the performance evaluation system may propose a personalized goal based on an employee current performance level, i.e. his last evaluation. The algorithm could be:

```
SLP₍ᵢ₎ = Employee last rating
IF SLP₍ᵢ₎ = HSLP THEN
  Proposed goal = HSLP
OTHERWISE
  Proposed goal = SLP₍ᵢ₊₁₎
ENDIF
```

If an employee was rated at the top of the scale, the proposed goal would be to remain at the top; otherwise, it would be set one level up from his current rating. Thus, the proposed goal is the smallest performance improvement that may be measured. Such goal is certainly the most achievable but it might not be difficult enough to be challenging. This is why the goal is said to be proposed. Bokko [1994:11] also wrote, “Performance standards should be as difficult as possible, while being achievable.” The supervisor can set a higher (more difficult) goal. There is a compromise to be made between goal difficulty and goal achievability. Clear and specific Standardized Levels of Performance aid supervisors doing this efficiently.

Due to its format and rating method, the Step Rating Scale will significantly reduce rating errors like leniency and halo. Nevertheless, in cases where a rater would voluntarily manipulate his ratings, some controls must be introduced. This topic will be addressed in the section Detailed Description.

The present invention is an improved method and system superior to prior art rating scale methods and systems. Accordingly, an object of the invention is to provide a system and method to create and calibrate a rating instrument that can effectively differentiate performances. In the exemplary embodiment, such instrument can be a job factor used to differentiate the performances of employees.

Another object of the present invention is to provide a system and method to propose automatically a difficult yet achievable goal. In the exemplary embodiment, such difficult yet achievable goal can be an individual goal proposed to improve the performance of an employee.

Still another object of the present invention is to provide a system and (rating) method to reduce significantly rating errors. In the exemplary embodiment, example of rating errors could be leniency and halo.

By calibrating a Step Rating Scale, performances may be differentiated even when the differences between them are minimal. In an exemplary embodiment of the present invention, by differentiating employee performances, the system output may be used, for example, by an organization compensation system in order to assist deciding on merit-pay increases and bonus allocations. It may also be used by an organizational development system to assist deciding on promotions or by a training and development system to assist deciding on individual areas to develop.

When performances evolve and concentrate around a new level, the Step Rating Scale may be recalibrated to recognize this change and to maintain its differentiation capability. In the exemplary embodiment, especially in a context of continuous improvement, as the Level of Performance Observed of employees increase near the Highest Standardized Level of Performance, either a Step Rating Scale can be expanded by adding Standardized Level(s) of Performance above the current Highest Standardized Level of Performance or by modifying the Highest Standardized Level of Performance itself to increase the level of performance it describes. In doing this, even the best performers in a group of employees will have a goal to incite them improving their performance.

The system and method of the preset invention may automatically propose a difficult yet achievable goal, i.e. the next Standardized Level of Performance above current performance level. Such goals will incite employees to achieve success. In addition, by proposing a goal from one's current performance level, such goal is automatically a personalized goal.

Standardized Norms of Performance are based on critical incidents to ensure Standardized Levels of Performance content validity.

The present invention has the capability to significantly reduce rating errors like leniency and halo. Firstly, because Standardized Levels of Performance are specific rather than ambiguous. Secondly, because the Step Rating Scale rating method (i.e. Rule 2) is so constraining that a rater must concentrate his attention on one Standardized Level of Performance at a time, which acts as a Go/No-Go barrier. While evaluating a Level of Performance Observed with regards to a certain job factor, for each Standardized Level of Performance considered, Rule 2 demands a rater to justify his judgment, at least to himself, and makes it much more difficult to be lenient. As well, for each Step Rating Scale based job factor, a rater must concentrate his attention on one Standardized Level of Performance at a time [Rule 2] and consequently looses perspective of the ratee overall performance, therefore reducing halo rating errors.

The Step Rating Scale will reduce leniency in cases of self-rating for the same reasons presented in the previous paragraph.

The two previous paragraphs illustrate several benefits. Firstly, less rating errors means ratings that are more reliable. Secondly, ratings and self-ratings will demonstrate more convergence. Thus, ratings and self-ratings will be more comparable and will converge. As well, two raters judging equivalent Levels of Performances Observed will produce comparable ratings because of the absence of ambiguousness in the Step Rating Scale format and rating method.

The present invention consists to a greater ratee acceptance of ratings recorded in the performance evaluation system. Several reasons support this. Firstly, the Step Rating Scale format clearly informs an employee about which performance level to reach to improve his rating. Secondly, the Step Rating Scale format and rating method allow for self-rating. Thirdly, they constrain rater's judgment leaving little room to supervisors to interpret ratee performance. Fourthly, the previous reason leads us to what is more open to interpretation and discussion, the Level of Performance Observed itself. Employees have the right and the possibility to remind their supervisor of elements of performance that the supervisor may have forgotten or missed in establishing the employee Level of Performance Observed. With such additional information, the supervisor might have to revise his evaluation to the benefit of the employee. Fifthly, the previously mentioned convergence between ratings and self-ratings is evidence of mutual agreement.

Using the present invention, supervisors may feel more adequate in their rater role. Firstly, because of greater ratee acceptance of ratings. This contributes to supervisors building self-confidence at rating performances. Secondly, supervisors feel they are better tooled to confront their employees. They can rely on Standardized Levels of Performance and the Level of Performance Observed to explain their rational especially in cases of un-welcomed ratings. Thus, supervisors can justify their ratings much more easily.

In the present invention, ratings may be set directly on the rating scale format, which is a strong preference of supervisors.

Using the present invention, supervisors may have more ownership in a Step Rating Scale based performance evaluation system. In most instances, job factors designed with a Step Rating Scale need to be calibrated. Calibrating involves, fine-tuning Standardized Levels of Performance and validating ratings distributions. These steps require input from supervisors and such contribution consequently strengthens their feeling of ownership of the performance evaluation system.

The Step Rating Scale may provide an effective documentation to manage performance. In particular, it may provide guiding information to supervisors to coach individual employees to improve their performance, and to better answer questions about what an employee must do to improve his performance. In addition, it may also provide guiding information to an employee to self-manage his performance. For example, goals may clearly be identified on a Step Rating Scale, and Standardized Levels of Performance may be viewed as a roadmap to improve performance and to self-reinforce effective behavior.

The present invention may provide a greater rater acceptance of a Step Rating Scale based performance evaluation system. Many of the aspects of the present invention—like feeling more adequate in their rater role, rating time efficiency, having more ownership, rating directly on the scale, and the documentation being a coaching-aid—contribute to this.

The Step Rating Scale is a very time-efficient evaluation tool. There are several reasons for this. Firstly, due to the design wizards of the evaluation design data module 103, creating or modifying a Step Rating Scale based job factor requires little time, i.e. few minutes, and no special professional help. Secondly, it is very user-friendly. Thirdly, because of the Step Rating Scale rating method, i.e. Rule 2, rating performances requires little cognitive effort. Indeed, the cognitive process involved is closer to a selection process than a judging process. Supervisors do not have to interpret different “shades of grey” between two Standardized Levels of Performance. Fourthly, establishing a difficult yet achievable individual goal requires very little time. A supervisor may accept the individual goal automatically proposed by the performance evaluation system or set the goal to a higher Standardized Level of Performance. Fourthly, a Step Rating Scale based job factor is less demanding on raters to gather a wide spectrum of observations of employee performance. Especially due to the quantifiers utilized with the Step Rating Scale, little observation may be sufficient to establish a ratee's Level of Performance Observed because the Step Rating Scale leads to “observing by exception”. For example, if a supervisor remembers an instance where the ratee did not performed the behavior “A”, then all Standardized Levels of Performance including the “Always” frequency for the behavior “A” may readily be discarded because the ratee no longer satisfy. Therefore, only the next Standardized Level of Performance down the scale must be kept in mind when observing employee performance. This approach per exception is very compatible with how managers operate in practice.

The Step Rating Scale based performance evaluation system may provide the flexibility to efficiently maintain and more importantly re-calibrate job factors rating scales as employee performances improve over time. Such flexibility enables an organization to maintain at a low cost, year after year, the validity of their performance evaluation system.

Little training is required to perform quality evaluations with a Step Rating Scale. This translates into tremendous cost reductions in human resources training expenses. The Step Rating Scale format and method are clear, specific and easy to understand. Behaviors are critical incidents of job factors and require little explanations as well. The same can be said about the quantifier set presented in the section Detailed Description. For example, the quantifier “Always” requires little explanations. A quantifier like “Except few exceptions”, if needed, may be defined directly on the job factor evaluation form, for example “No more than 3 times”. As for the quantifier “Usually”, it corresponds to anything else that does not correspond to other quantifiers. A great benefit of the Step Rating Scale to any organization is that no particular knowledge, skills or abilities is required to become a good rater.

Step Rating Scales based performance evaluation system may provide the capability to control the quality of ratings before processing them to generate employee scores. Ratings may be computed into rating quality indicators. Supervisors may have political, managerial, personal or other reasons to manipulate intentionally ratings rather than doing a rational assessment of performances. With prior art rating scales, organizations rely almost exclusively on time consuming and costly approval procedures to discourage supervisors from doing so. In practice, this does little to the fact that approvers are usually too removed from the employee evaluated to be able to suspect ratings manipulation by a supervisor. A Step Rating Scales based performance evaluation system reporting on rating quality indicators to management and/or human resources may have a significant dissuasive impact on supervisors to discourage them from attempting to manipulate ratings In such settings, supervisors are very aware that suspicious ratings could be challenged. Obviously, in cases of employment terminations for example, evaluations approvals may still be required by company policies.

The Step Rating Scaled based performance evaluation system can reduce an organization legal liability risk because of significantly less bias and less discrimination than prior art rating scales due to three issues previously discussed. A capability to significantly reduced rating errors, a greater acceptance of ratings by employees, and the capability to control ratings quality therefore significantly discouraging raters from attempting to manipulate ratings.

Management By Objective types of job factors may benefit from the Step Rating Scale to differentiate between different levels of objective achievement. Making use of the Step Rating Scale method with Management By Objective type of job factors provides the same benefits as with behavioral type of job factors.

The skilled addressee will appreciate that the construction and structure of Standardized Levels of Performance make them clear, specific, externally defined and quantifiable. Secondly, the Step Rating Scale calibration method, where for each consecutive SLP₍ᵢ₎ and SLP₍ᵢ₊₁₎, the standardized rating error SRE_{(i+1,i)} is relatively small enough, enables performances differentiation. Thirdly, the rating rules of the Step Rating Scale method that enable using specific Standardized Levels of Performance to differentiate performances accurately, reliably and efficiently.

A Step Rating Scale based performance evaluation system provides a system and a method superior to prior art rating scales regarding its superiority to better differentiate among performances, to automatically propose difficult yet achievable goals, and to significantly reduce rating errors.

According to one aspect of the invention, there is provided a method for generating a rating scale to be used in an evaluation form, the method comprising providing a plurality of elements to rate, providing a plurality of sets of qualifying quantifiers for quantifying the elements to rate, associating at least one of the qualifying quantifiers to each of the plurality of elements to rate and automatically generating a plurality of rating levels, each comprising a combination of the elements to rate with a corresponding qualifying quantifier from its associated set of qualifying quantifiers to form the rating scale.

According to another aspect of the invention, there is provided a method for performing an evaluation, the method comprising providing a plurality of elements to rate, providing a plurality of sets of qualifying quantifiers for quantifying the elements to rate, associating at least one of the qualifying quantifiers to each of the plurality of elements to rate, automatically generating a plurality of rating levels, each comprising a combination of the elements to rate with a corresponding qualifying quantifier from its associated set of qualifying quantifiers to form the rating scale, displaying the generated plurality of rating levels to a user and selecting a rating level of the displayed generated plurality of rating levels to thereby perform the evaluation.

According to another aspect of the invention, there is provided a rating scale to be used in an evaluation form, the rating scale comprising a plurality of rating levels, each comprising a plurality of elements to rate and a plurality of qualifying quantifiers, each associated to a corresponding one of the plurality of elements to rate.

Further details of these and other aspects of the present invention will be apparent from the detailed description and figures included below.

### BRIEF DESCRIPTION OF THE FIGURES

FIG. 1 shows a block diagram of the performance evaluation system;

FIG. 2 shows the components of a computer network system;

FIG. 3 shows a flow chart showing some operations of the evaluation design data module used in system of FIG. 1;

FIG. 3A shows a flow chart showing some operations of the evaluation design data module used to create a new job factor;

FIG. 3B shows a flow chart showing some operations of the evaluation design data module used to modify or delete a job factor;

FIG. 3C shows a flow chart showing some operations of the evaluation design data module used to create a new evaluation form;

FIG. 3D shows a flow chart showing some operations of the evaluation design data module used to modify or delete an evaluation form;

FIG. 4 shows a flow chart showing some operations of the evaluation results data module used in system of FIG. 1.

FIG. 4A shows a flow chart showing the operations of the evaluation results data module used by managers;

FIG. 4B shows a flow chart showing some operations of the evaluation results data module used by managers to rate employees;

FIG. 4C shows a flow chart showing some operations of the evaluation results data module used to modify ratings and employees self-ratings during a formal performance review;

FIG. 4D shows a flow chart showing some operations of the evaluation results data module used by employees to perform self-ratings;

FIG. 5 shows a flow chart showing some operations of the evaluation administration module used in system of FIG. 1;

FIG. 6 shows a screenshot of a form used in the system of FIG. 1 to select an evaluation method to design a job factor titled “Decision Making Skills”;

FIG. 7 shows a block diagram of a wizard used in the system of FIG. 1 to design a job factor based on a 4-Standardized Norm of Performance Step Rating Scale with the quantifier set “AEUOR”;

FIG. 7A shows a screenshot of a form used to design a job factor, based on a 4-Standardized Norm of Performance Step Rating Scale with the quantifier set “AEUOR”;

FIG. 7B shows a block diagram of a wizard, at different calibration stages, used to design a job factor based on a 4-Standardized Norm of Performance Step Rating Scale with the quantifier set “AEUOR”;

FIG. 7B1 (Top) shows a screenshot of a the top part of a form used to design a job factor, based on a 4-Standardized Norm of Performance Step Rating Scale with the quantifier set “AEUOR”, before the calibration of the scale;

FIG. 7B1 (Bottom) shows a screenshot of a the bottom part of a form used to design a job factor, based on a 4-Standardized Norm of Performance Step Rating Scale with the quantifier set “AEUOR”, before the calibration of the scale;

FIG. 7B2 (Top) shows a screenshot of a the top part of a form used to design a job factor, based on a 4-Standardized Norm of Performance Step Rating Scale with the quantifier set “AEUOR”, during the calibration of the scale;

FIG. 7B2 (Bottom) shows a screenshot of a the bottom part of a form used to design a job factor, based on a 4-Standardized Norm of Performance Step Rating Scale with the quantifier set “AEUOR”, during the calibration of the scale;

FIG. 7B3 shows a screenshot of a form used to design a job factor, based on a 4-Standardized Norm of Performance Step Rating Scale with the quantifier set “AEUOR”, after the calibration of the scale is completed;

FIG. 8 shows a block diagram of a job factor, at different stages, which may be used in the embodiment of FIG. 1 to evaluate “Decision Making Skills”;

FIG. 8A shows a screenshot of the job factor of FIG. 8, with an 9-Standardized Level of Performance Step Rating Scale, used by a rater to rate an employee Level of Performance Observed;

FIG. 8B shows a screenshot of the job factor of FIG. 8, with a 9-Standardized Level of Performance Step Rating Scale, used by a ratee to self-evaluate his performance;

FIG. 8C shows a screenshot of the job factor of FIG. 8, with an 9-Standardized Level of Performance Step Rating Scale, used by both rater and ratee during a formal performance review to enable them modifying and finalizing respectively their evaluation and self-evaluation;

FIG. 8D shows a screenshot of a pop-up window that presents rating instructions for the job factor of FIG. 8;

FIG. 9 shows a screenshot of the job factor “Job Knowledge” based on an 8-Standardized Level of Performance Step Rating Scale with the quantifier set “AAMF”, used in the embodiment of FIG. 1;

FIG. 10 shows a screenshot of the job factor “Inventory Management-1” based on an 2-Standardized Level of Performance Step Rating Scale with the quantifier set for a Management By Objective type of evaluation instrument, used in the embodiment of FIG. 1;

FIG. 11 shows a screenshot of the job factor “Inventory Management-2” based on an 3-Standardized Level of Performance Step Rating Scale with the quantifier set for a Management By Objective type of evaluation instrument, used in the embodiment of FIG. 1;

FIG. 12 shows a screenshot of the job factor “Inventory Management-3” based on another 3-Standardized Level of Performance Step Rating Scale with the quantifier set for a Management By Objective type of evaluation instrument, used in the embodiment of FIG. 1;

FIG. 13 shows a screenshot of the job factor “Inventory Management-4” based on a 4-Standardized Level of Performance Step Rating Scale with the quantifier set for a Management By Objective type of evaluation instrument, used in the embodiment of FIG. 1; and

FIG. 14 shows a screenshot of question #10 of an “Employee Satisfaction Survey” questionnaire based on a 10-Standardized Level of Performance Step Rating Scale with the quantifier set “AEUOR”, that could be used to gather information from employees regarding “performance management” in a system similar to the one of FIG. 1.

### DETAILED DESCRIPTION

In the exemplary embodiment, performances mean performances achieved by employees in a work setting. For example, performances might be a behavior, a competence, or the result of actions/decisions taken by an employee. The nature of results may vary greatly. There are financial results, like sales volume, costs and profit margin. There are also non-financial results expressed quantitatively, for example employee sick days or production rates. In addition, there are non-financial results expressed qualitatively for example, performing an action as well as creating/modifying a project, a tool, a system, or information.

A performance evaluation system according to the present invention may provide a tool to perform human resources evaluations via a computer communication network. Employee evaluations may be performed based on qualitative or quantitative job factors. Participants in the evaluation process may access the performance evaluation system via a communications network, such as a local area network (LAN) or an intranet or the Internet, with a network access device, such as a computer.

A performance evaluation system according to the present invention may evaluate an employee's performances accurately and reliably. It may be used to differentiate an employee level of performance achieved, to set an individual goal per job dimension, to determine if that goal was achieved, and to identify strengths or development needs. The performance evaluation system may be used to inform several human resources processes like compensation, job promotion, and decision-making processes regarding an employee's performance. A performance evaluation system may also be used to link individual performance objectives to a particular corporate strategy or goal.

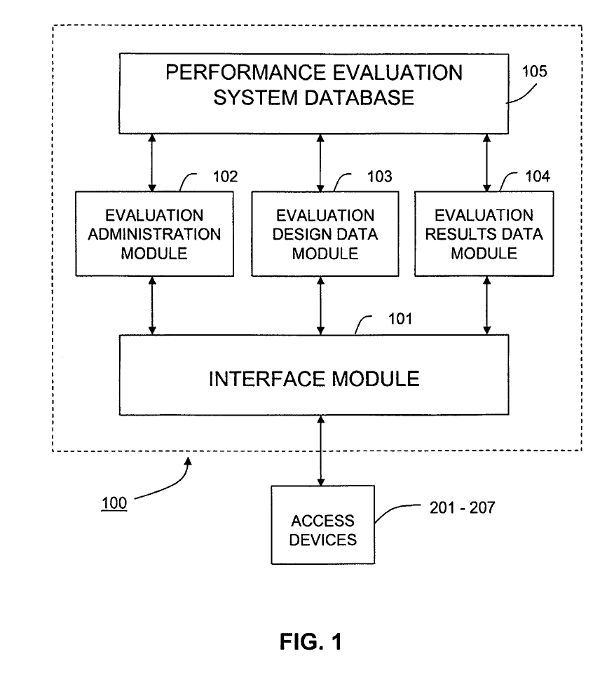

FIG. 1 shows a block diagram of one embodiment of a performance evaluation system 100. In the exemplary embodiment, system 100 runs on host system 280 and comprises an interface module 101 that provides users—raters, ratees, performance evaluation system administrator, performance evaluation system designer, etc—operating any of computers 201-207 with access to the performance evaluation system services provided by system 100. The performance evaluation system designer provides design information to system 100 through a variety of forms that are displayed by the evaluation design data module 103 on the display screen of any computers 201-207. Design information received and designed evaluation tools, like job factors and evaluation forms, may be centrally stored in the performance evaluation system database 105 or distributed to user computers 201-207. The system administrator provides system administration information to the system 100 through a variety of administration forms that are displayed by the evaluation administration module 102 on the display screen of any computers 201-207. Administration information received is centrally stored in the performance evaluation system database 105. Raters and ratees provide performance evaluation information to the system 100 through a variety of evaluation forms that are displayed by the evaluation results data module 104 on the display screen of any of computers 201-207. Evaluation information received is centrally stored in the performance evaluation system database 105 thereby simplifying the processing of employees performances throughout the organization.

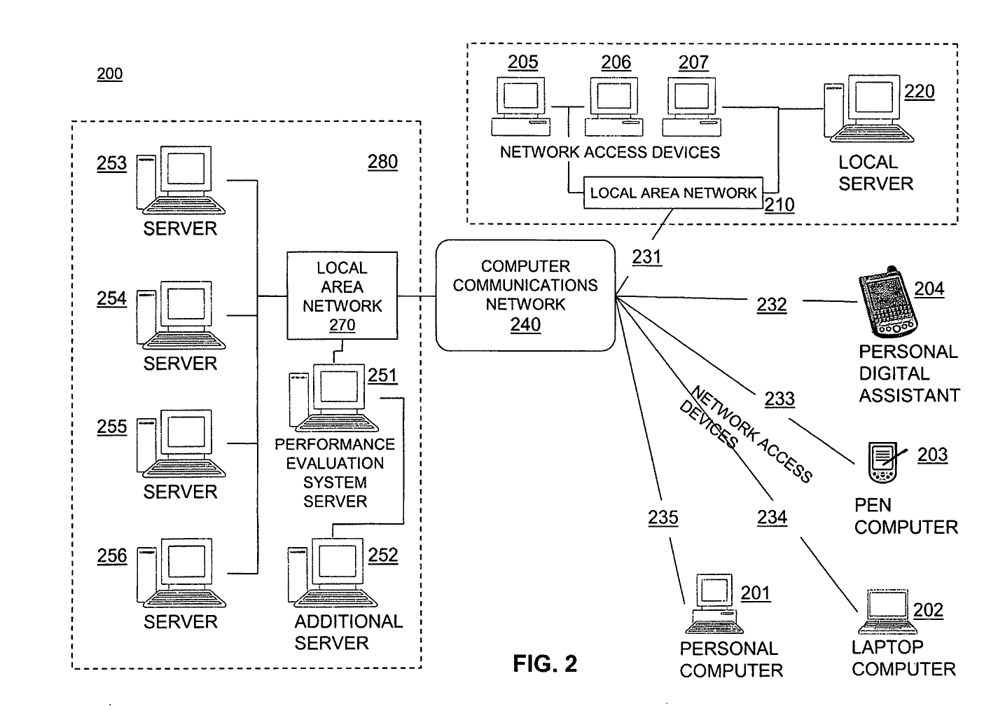

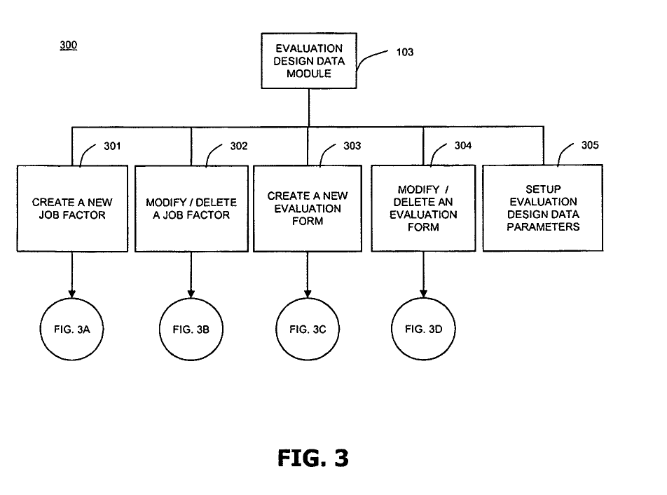

Referring now to FIG. 2, there is shown a network of computers 200 that may be used in an implementation of a performance evaluation system. The network 200 comprises a host system 280 and users, such as rater/ratee, computers 201-207. Each of the computers may comprise a processor, memory, user input device, such as a keyboard and/or mouse, and a user output device, such as a video display and/or printer. The user computers 201-207 may communicate with the host 280 to obtain data stored at the host 280, such as employee data or rating information. The user computers 201-207 may interact with the host computer 280 as if the host was a single entity in the network 200. However, the host 280 may comprise multiple processing and database sub-systems, such as cooperative or redundant processing and/or database servers 251-256, that may be geographically dispersed throughout the network 200. In some implementations, user computers 205-207 may communicate with host 280 through a local server 220. It will be appreciated that the local server 220 may be a proxy server or a caching server. The server 220 may also be a co-host server that may serve performance evaluation systems content and provide functionality such as evaluation forms and reports to user computers 205-207.

A user may access the host 280 using communications software executed at their computer 201-207. The communication software may comprise a generic hypertext markup language (HTML) browser, such as Microsoft Internet Explorer, hereafter called “WEB browser”, executable routines such as standard queries, or other known means for accessing data over a computerized communications network. The user software may also be a proprietary browser, and/or other host access software. In some embodiments, an executable program, such as a Java™ program or a Microsoft Access™ program, may be downloaded from the host 280 to, or already installed on, the user computers 201-207 and executed at their computer.

In the exemplary embodiment or in any other embodiment discussed, performance evaluation systems commands like “Save”, “Abandon”, “Go to another menu”, “Quit”, “Exit”, and so on, as well as the steps to activate those commands are assumed to be known and are not discussed, except in cases where it is required.

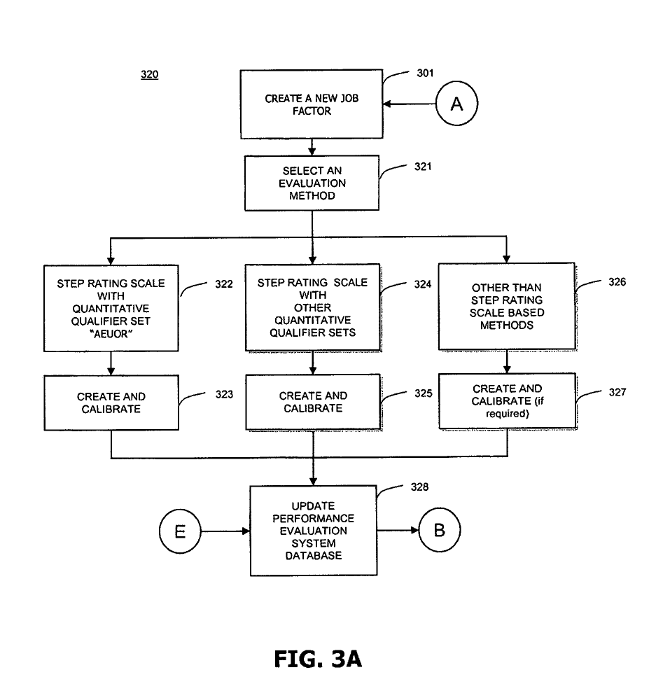

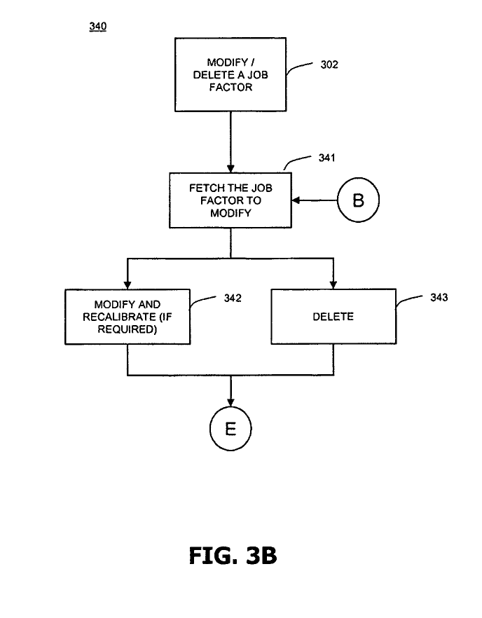

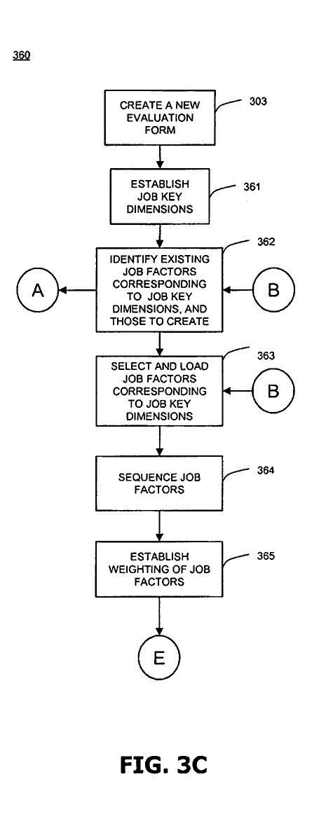

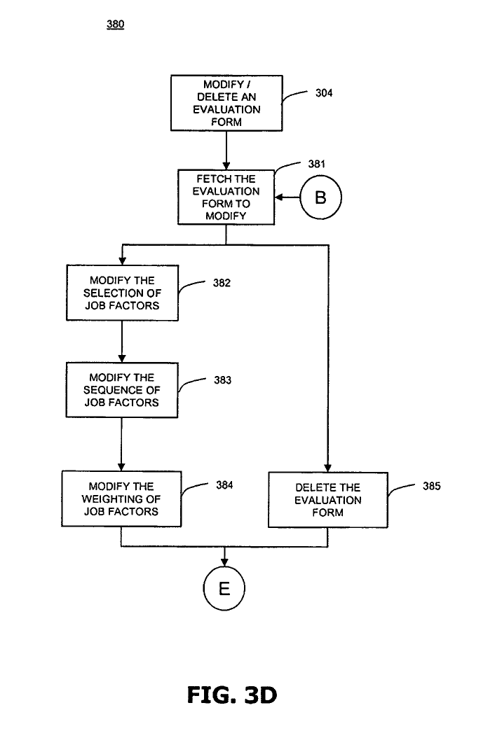

A performance evaluation system according to the present invention may comprise computer-automated steps for managing system and technical components of a performance evaluation system. Referring now to FIG. 3, there is shown a flowchart of an exemplary evaluation design data module 103 process 300 that may be used, among other things, to create a new job factor 301.

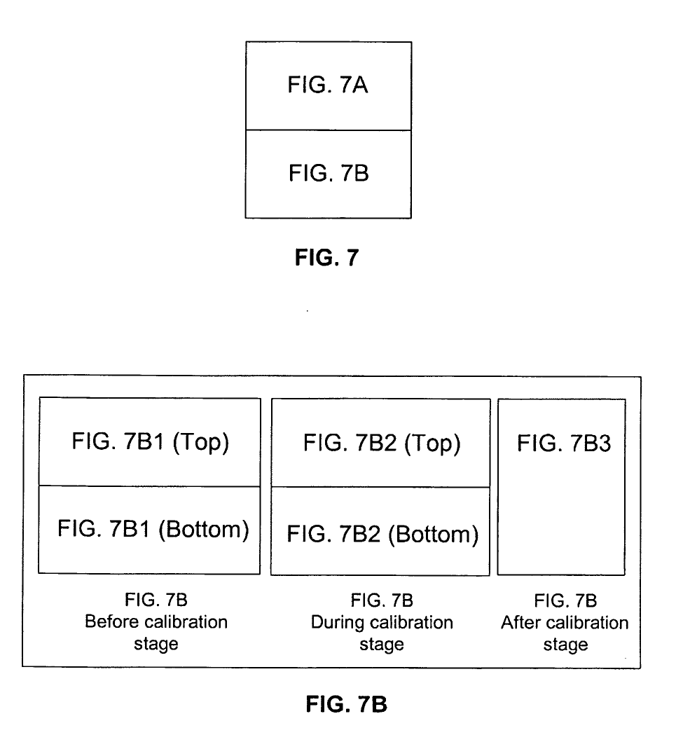

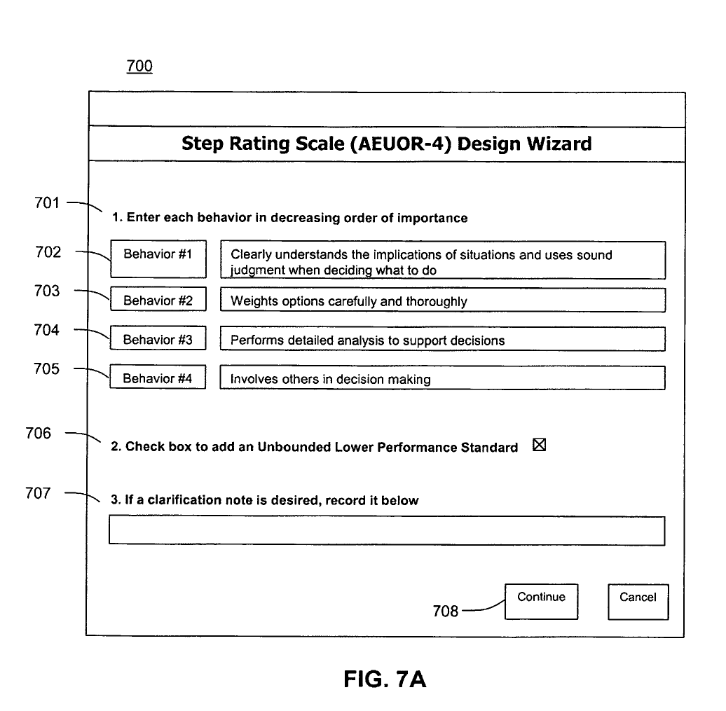

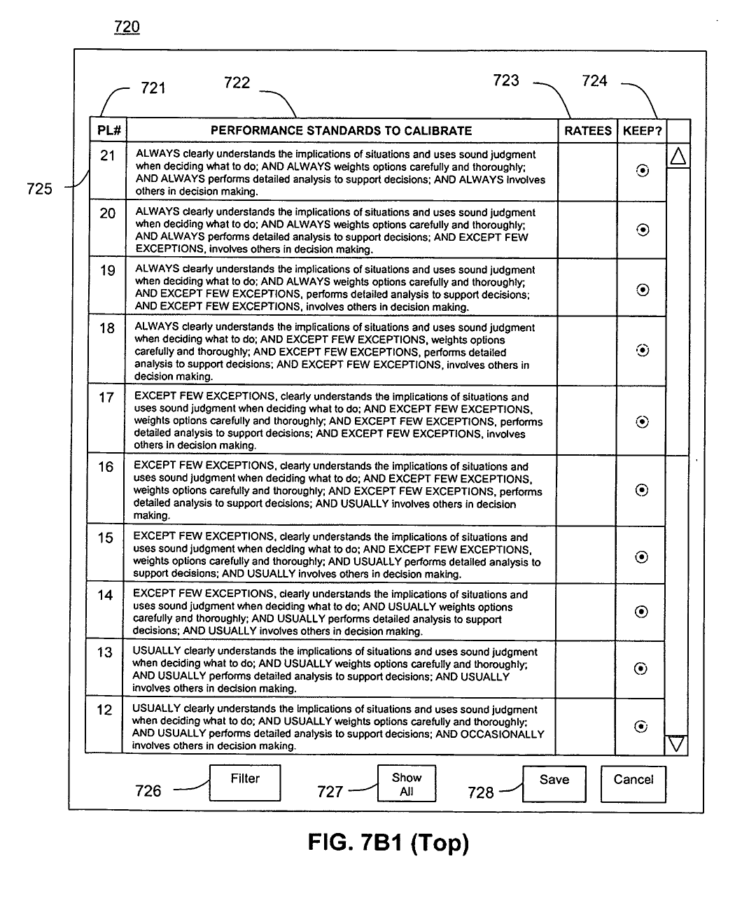

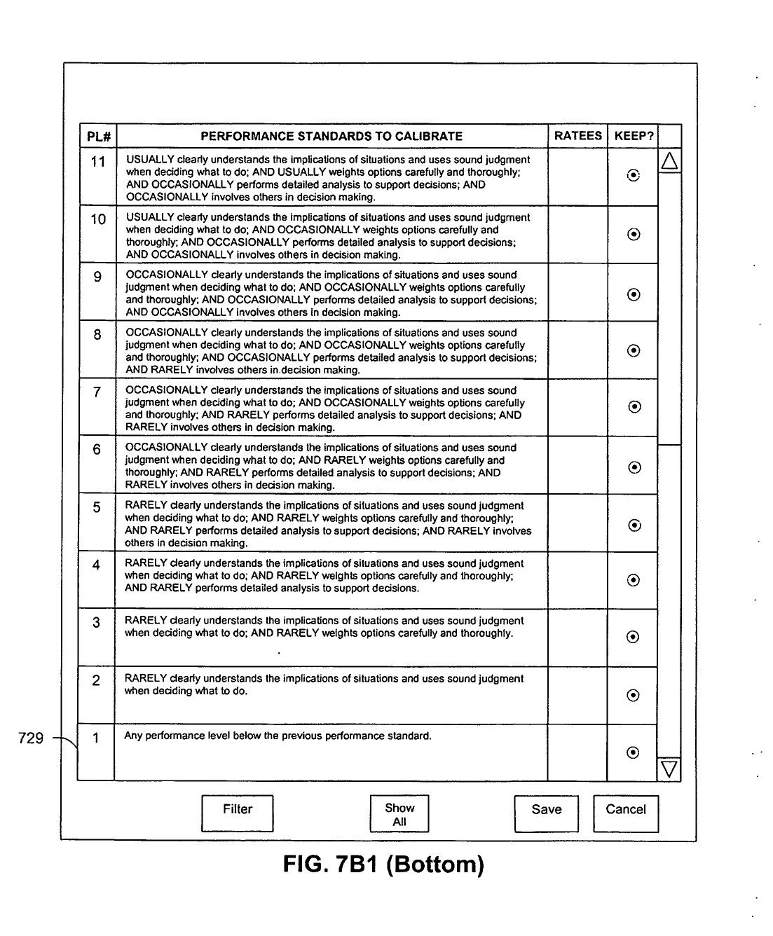

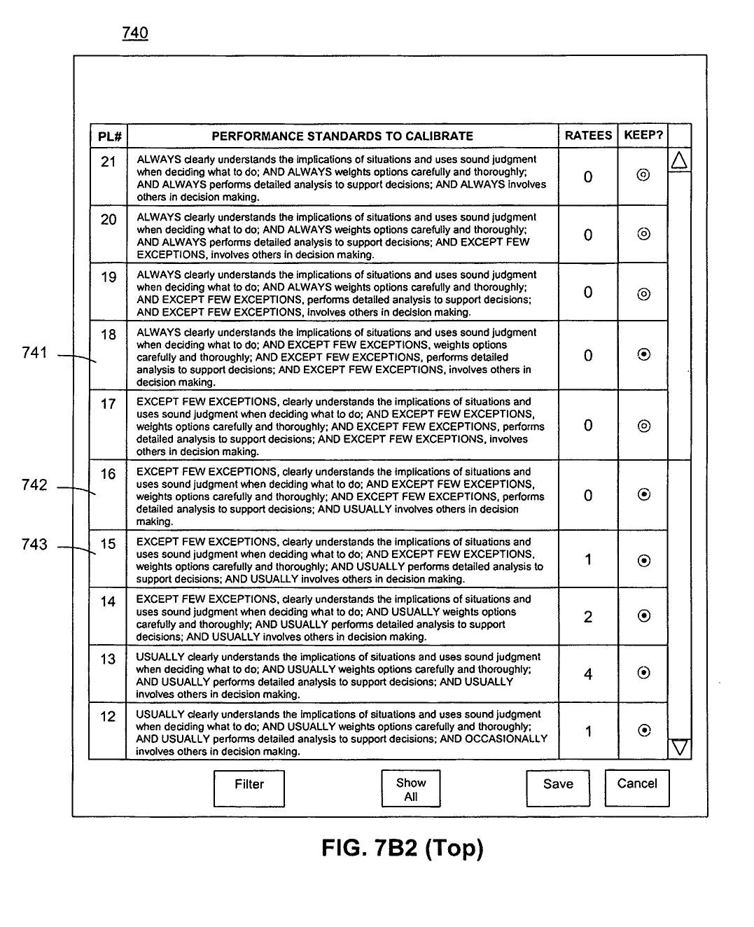

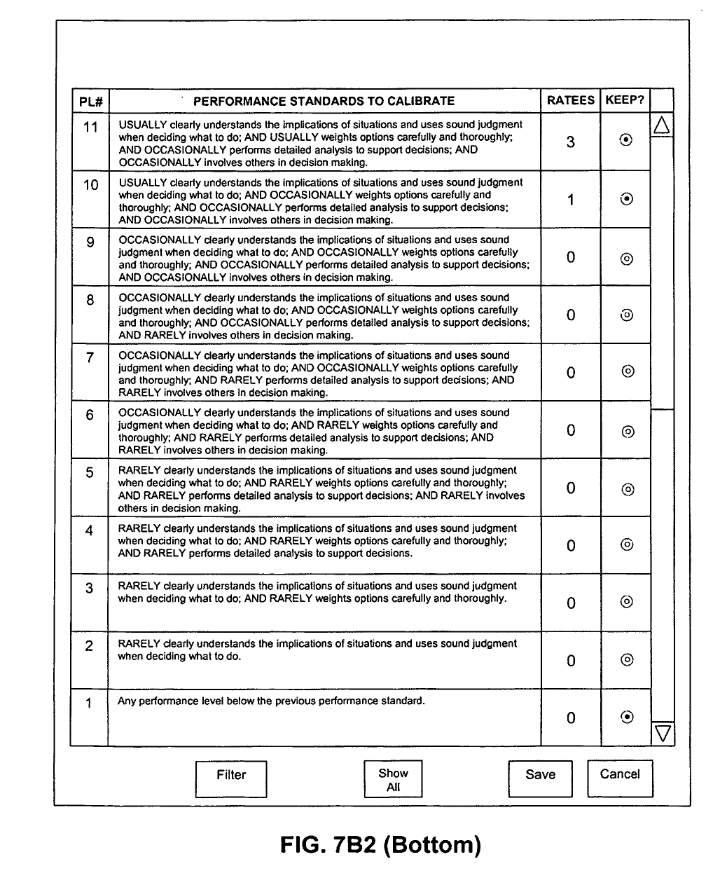

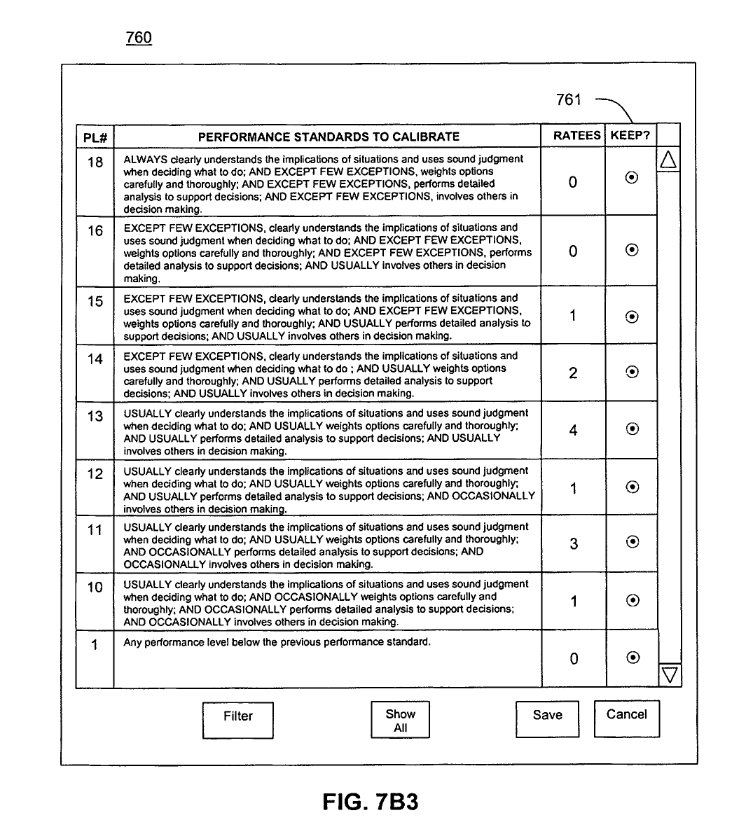

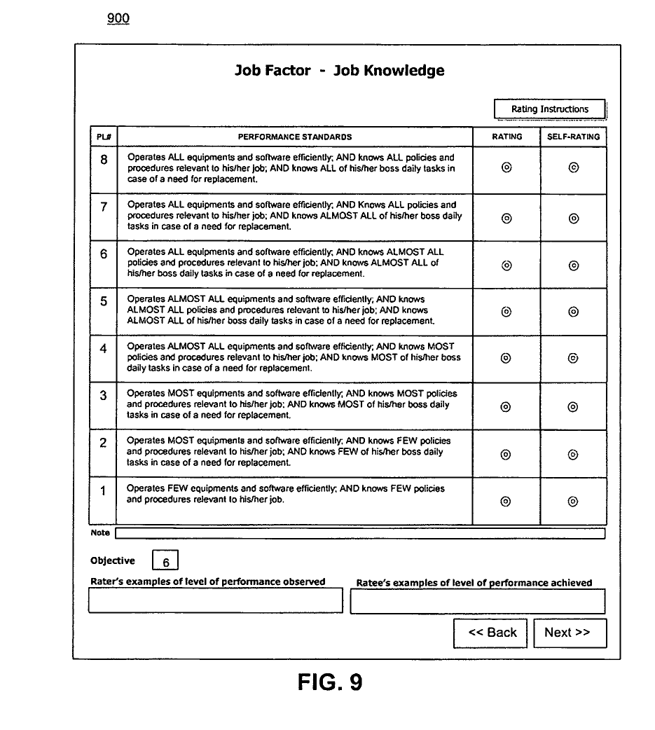

Referring now to FIG. 3A, there is shown a flowchart extension of FIG. 3 which shows an exemplary process 320 that may be used to create a new job factor. The performance evaluation system designer may access a computer screen that enables him, through menus or hyperlinks, to access menu 301, and to select an evaluation method 321. By selecting the Step Rating Scale method with the quantifier set “AEUOR” 322, the performance evaluation system designer loads a wizard 323 to create a behavioral job factor. The details of this wizard are presented in sections discussing FIG. 7. Different applications of the Step Rating Scale method as with other quantifier sets 324 may be selected with their respective wizards 325. The FIG. 9 presents an example of a Step Rating Scale with another quantifier set. As well, other than Step Rating Scale based evaluation methods 326 may be selected with their respective wizards 327. Next, all job factors are added 328 to the performance evaluation system database 105.

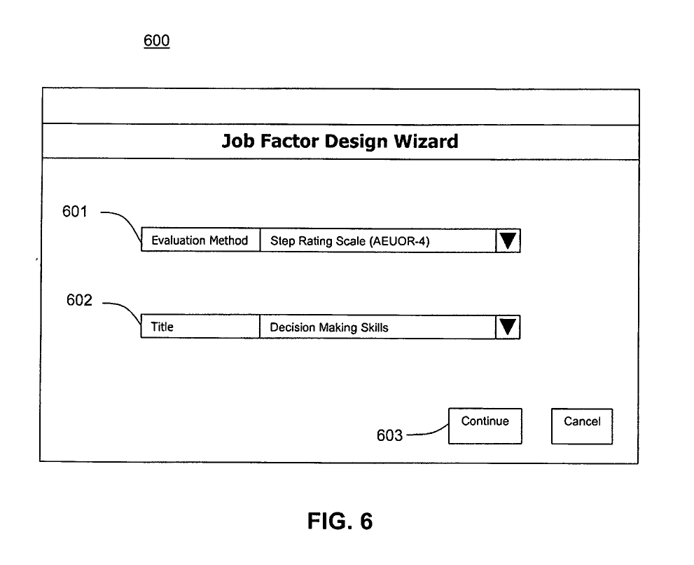

Referring now to FIG. 6, there is shown a screenshot 600 through which the performance evaluation system designer provides information to system 100. Functional interaction with the Job Factor Design Wizard 600 may be accomplished via a graphical user interface or other interactive medium operative with a network access device. To create a new job factor, the performance evaluation system designer begins by selecting a specific evaluation instrument. In the exemplary embodiment, a 4-Standardized Norm of Performance Step Rating Scale method with the quantifier set “AEUOR” 601 has been selected. The 4-Standardized Norm of Performance indicates a Step Rating Scale allowed using a maximum of four Standardized Norms of Performance per Standardized Level of Performance. Finest performance differentiation usually calls for increasing the maximum number of Standardized Norms of Performance. As well, by increasing the maximum number of Standardized Norms of Performance a supervisor benefits from a broader range of Standardized Norms of Performance to provide feedback to its employees.

Still referring to FIG. 6, the designer continues by entering the title name of the new job factor to create. In the exemplary embodiment, the “Decision Making Skills” job factor 602 is to be created.

Referring now to FIG. 7A, there is shown a screenshot 700 of FIG. 7 through which the performance evaluation system designer provides information to system 100. A list of valid behaviors 701 representative of the job dimension, ranked in decreasing order of importance is entered. Those key behaviors may comprise important decision-making skills to ratee's position, the importance of which may be based upon the needs of the organization. It is assumed that the Critical Incident Technique is used to determine what are the most important behaviors that are valid and effective to the job dimension. Because the text expressions of the behaviors are processed by the system 100 to generate Standardized Norms of Performance, careful attention must be given to the wording of behaviors. In the language of the exemplary embodiment (English), the designer must make sure that all behaviors begin by a verb at the third person singular or an adverb followed by a verb at the third person singular (for example: Makes . . . , Clearly understands . . . ,). Those skilled in the art will recognize that the present embodiment may be implemented to process Standardized Norms of Performance in different languages than in English.

Next, by selecting the check box 706, the designer also communicates to the system 100 if an unbounded Lowest Standardized Level of Performance is to be added to the Standardized Level of Performance set 722 to generate. The option “Add an unbounded lower performance standard” 706 forces at the bottom of the rating scale a Lowest Standardized Level of Performance accounting for performances below the previous Standardized Level of Performance. The Lowest Standardized Level of Performance text expression may read as “Any performance below the previous performance standard” 729.

It is assumed that each valid behavior wording excludes any words or series of words, especially subjective qualifiers, which may be subjected to interpretation. Most of the time, it may be done without them. If the risk of a subjective interpretation cannot be excluded, a clarification note 707 should be added at the bottom of the scale to eliminate interpretation by providing specific definition(s) and/or quantitative information. Valid behaviors exempt from subjective qualifiers are by far preferable.

Once section 700 is completed, the designer selects the ‘Continue’ command button 708 to continue to FIG. 7B1. The ‘Continue’ command button launches Algorithm 1 to generate and display Standardized Levels of Performance. They are generated by combining each behavior text expression 702-705 with the text expressions of the quantifier set “AEUOR” used by Algorithm 1.

In the exemplary embodiment, Algorithm 1 utilizes the quantifier set “AEUOR” where each letter stands respectively for “Always”, “Except few exceptions”, “Usually”, “Occasionally” and “Rarely”. The “Always” quantifier refers to a behavior that has been demonstrated by an employee during the evaluation period without any exceptions, not even once. The “Except few exceptions” quantifier refers to a behavior that has been demonstrated during the evaluation period with few exceptions. “Few exceptions” refers to (a) a very small range of occurrences where the behavior has not been demonstrated, (b) where that range may easily be quantified, and (c) well understood by rater and ratees. As an indication, in most cases, what can correspond to “few exceptions” may be counted on the fingers of a single hand. The “Rarely” quantifier is the opposite of the “Except few exceptions” quantifier. The “Rarely” quantifier refers to a behavior that has been demonstrated in few occurrences during the evaluation period. “Rarely” refers to (a) a small range of occurrences where the behavior has been demonstrated, (b) where that range may easily be quantified, and (c) well understood by rater and ratees. As an indication, in most cases, what corresponds to “Rarely” may be counted on the fingers of a single hand. The “Occasionally” quantifier refers to a behavior that has been demonstrated during the evaluation period (a) more often than “Rarely” but not as often as “Except few exceptions”, and (b) it has been demonstrated sporadically. In cases, where either “Except few exceptions”, “Rarely” or “Occasionally” quantifiers may be subject to interpretation, a clarification note 707 should be added to the Step Rating Scale to eliminate interpreting a quantifier. Finally, the “Usually” quantifier refers to a behavior that has been demonstrated during the evaluation period (a) more often than “Occasionally” but not as often as “Except few exceptions”, and (b) on a regular basis. Therefore, a rater or a ratee considering at which frequency a behavior has been demonstrated during the evaluation period, must conclude that if none of the first four quantifiers presented above applies, he/she must default to the “Usually” quantifier.

A performance evaluation system based on the present invention may comprise job factors designed with Step Rating Scales that can have different numbers of Standardized Norms of Performance per Standardized Level of Performance, as well as different numbers of Standardized Levels of Performance per rating scale. In the exemplary embodiment, where Qₐ, Q_{b}, Q_{c}, and Q_{d}, designate quantifiers with a, b, c and d ranging from 1 to 5, where Bᵢ designates behaviors with i ranging from 1 to 4, where the number of Standardized Norms of Performance per Standardized Level of Performance can vary from a minimum of 1 to a maximum of 4, and where no permutation of Standardized Norms of Performance within Standardized Level of Performance is allowed, there is about 1295 unique Standardized Level of Performance combinations, hereafter called the “SLP_{(5,4)} Full Set”. About 18320 unique combinations can be obtained by the permutation of Standardized Norms of Performance. The SLP_{(5,4)} Full Set can be generated from the following algorithm:

```
For a = 1 to 5
  For b = 1 to 5
    For c = 1 to 5
      For d = 1 to 5
        QₐB₁ AND Q_{b}B₂ AND Q_{c}B₃ AND Q_{d}B₄
      Next d
      QₐB₁ AND Q_{b}B₂ AND Q_{c}B₃
      QₐB₁ AND Q_{b}B₂ AND Q_{c}B₄
      QₐB₁ AND Q_{b}B₃ AND Q_{c}B₄
      QₐB₂ AND Q_{b}B₃ AND Q_{c}B₄
    Next c
    QₐB₁ AND Q_{b}B₂
    QₐB₁ AND Q_{b}B₃
    QₐB₁ AND Q_{b}B₄
    QₐB₂ AND Q_{b}B₃
    QₐB₂ AND Q_{b}B₄
    QₐB₃ AND Q_{b}B₄
  Next b
  For i = 1 to 4
    QₐBᵢ
  Next i
Next a
```

In the exemplary embodiment, the Algorithm 1 of the system 100 automatically generates a Step Rating Scale with a subset of the SLP_{(5,4)} Full Set. Algorithm 1 generates twenty Standardized Levels of Performance. Such algorithm is application dependent. An additional Standardized Level of Performance may be added to the subset, if option 706 is selected. A performance evaluation system based on the present embodiment may use other algorithms to generate automatically any subset of the SLP_{(5.4)} Full Set.

```
Procedure Algorithm 1 ( )
‘Used by “Step Rating Scale (AEUOR-4) Design Wizard” (FIG. 7B).
‘Declarations
Dim Chk706 As Boolean
Dim Q[4] As String Array ′5-location array
Dim B[3] As String Array ′4-location array
Dim LSLP As String
Dim SNP[4,3] As String Array ′20-location array
Dim SLP[20] As String Array ′21-location array
‘Quantifier set “AEUOR”
Set Q[0] = “ALWAYS”
Set Q[1] = “EXCEPT FEW EXCEPTIONS,”
Set Q[2] = “USUALLY”
Set Q[3] = “OCCASIONALLY”
Set Q[4] = “RARELY”
‘Option “Add an unbounded lower Standardized Level of Performance” 706.
Set LSLP = “Any performance level below the previous performance standard”
‘Load behaviors (FIG. 7A). The function “BehaviorTextPreparation” removes from the
behavioral text expression any trailing spaces, beginning spaces and any ending period,
and makes the first character a small capitalized character.
B[0] = BehaviorTextPreparation(GetBehavior1())
B[1] = BehaviorTextPreparation(GetBehavior2())
B[2] = BehaviorTextPreparation(GetBehavior3())
B[3] = BehaviorTextPreparation(GetBehavior4())
‘Load option selection (FIG. 7A)
Chk706 = GetOption706()
‘Create the cartesian product set of Standardized Norm of Performance text
‘expressions
FOR i = 0 TO 4
  FOR j = 0 TO 3
    SNP[i,j] = Q[i] & “ ” & B[j]
  NEXT j
NEXT i
‘Generate a 20 Standardized Levels of Performance subset of the SLP_{(5,4)} Full Set
SLP[0] = SNP[0,0] & “; AND ” & SNP[0,1] & “; AND ” & SNP[0,2] & “; AND ” &
SNP[0,3]
SLP[1] = SNP[0,0] & “; AND ” & SNP[0,1] & “; AND ” & SNP[0,2] & “; AND ” &
SNP[1,3]
SLP[2] = SNP[0,0] & “; AND ” & SNP[0,1] & “; AND ” & SNP[1,2] & “; AND ” &
SNP[1,3]
SLP[3] = SNP[0,0] & “; AND ” & SNP[1,1] & “; AND ” & SNP[1,2] & “; AND ” &
SNP[1,3]
SLP[4] = SNP[1,0] & “; AND ” & SNP[1,1] & “; AND ” & SNP[1,2] & “; AND ” &
SNP[1,3]
SLP[5] = SNP[1,0] & “; AND ” & SNP[1,1] & “; AND ” & SNP[1,2] & “; AND ” &
SNP[2,3]
SLP[6] = SNP[1,0] & “; AND ” & SNP[1,1] & “; AND ” & SNP[2,2] & “; AND ” &
SNP[2,3]
SLP[7] = SNP[1,0] & “; AND ” & SNP[2,1] & “; AND ” & SNP[2,2] & “; AND ” &
SNP[2,3]
SLP[8] = SNP[2,0] & “; AND ” & SNP[2,1] & “; AND ” & SNP[2,2] & “; AND ” &
SNP[2,3]
SLP[9] = SNP[2,0] & “; AND ” & SNP[2,1] & “; AND ” & SNP[2,2] & “; AND ” &
SNP[3,3]
SLP[10] = SNP[2,0] & “; AND ” & SNP[2,1] & “; AND ” & SNP[3,2] & “; AND ”
& SNP[3,3]
SLP[11] = SNP[2,0] & “; AND ” & SNP[3,1] & “; AND ” & SNP[3,2] & “; AND ”
& SNP[3,3]
SLP[12] = SNP[3,0] & “; AND ” & SNP[3,1] & “; AND ” & SNP[3,2] & “; AND ”
& SNP[3,3]
SLP[13] = SNP[3,0] & “; AND ” & SNP[3,1] & “; AND ” & SNP[3,2] & “; AND ”
& SNP[4,3]
SLP[14] = SNP[3,0] & “; AND ” & SNP[3,1] & “; AND ” & SNP[4,2] & “; AND ”
& SNP[4,3]
SLP[15] = SNP[3,0] & “; AND ” & SNP[4,1] & “; AND ” & SNP[4,2] & “; AND ”
& SNP[4,3]
SLP[16] = SNP[4,0] & “; AND ” & SNP[4,1] & “; AND ” & SNP[4,2] & “; AND ”
& SNP[4,3]
SLP[17] = SNP[4,0] & “; AND ” & SNP[4,1] & “; AND ” & SNP[4,2]
SLP[18] = SNP[4,0] & “; AND ” & SNP[4,1]
SLP[19] = SNP[4,0]
‘If option 706 is checked, set SLP[20] to the Lowest Standardized Level of Performance
IF Chk706 = True THEN
  SLP[20] = LSLP
ENDIF
‘Display the 21-Standardized Level of Performance Step Rating Scale (FIG. 7B1)
Call DisplayStepRatingScale (SLP)
End Procedure
```

In the exemplary embodiment, Algorithm 1 of system 100, generates a set of Standardized Levels of Performance 722 with each consecutive Standardized Level of Performance being a small-step performance improvement over the previous one. Such Step Rating Scale structure can logically be used to implement a continuous improvement process by establishing small-step improvement goal. If the option to add an unbounded Lowest Standardized Level of Performance 706 is selected, as in the exemplary embodiment, Algorithm 1 of system 100 generates it 729 as part of the set of Standardized Levels of Performance 722.

The format of Standardized Levels of Performance text expressions 722 may be improved to increase rating efficiency by improving rater reading speed and understanding. Such improvement may comprise, by way of non-limiting example, specific text style, text size, text color, of all or some Standardized Levels of Performance text expressions, Standardized Levels of Performance background color, etc. In the exemplary embodiment, Algorithm 1 of system 100 generates Standardized Levels of Performance text expressions 722 where quantifiers text expressions and Boolean operator text expression are capitalized. Other embodiments, may use other text formatting possibilities than the ones previously mentioned such as those provided with conventional text processing software, for example underlining, capitalizing, outlining, small capitalization, or a combination of them.

Often the set of Standardized Levels of Performance 722 must be calibrated. There are three common reasons for this. Firstly, the set may comprise more Standardized Levels of Performance than required to efficiently differentiate Levels of Performances Observed. Often the set of Standardized Levels of Performance 722 corresponds to a wide range of performances compared to the spectrum of performances observed in an organization at a certain point in time. Secondly, some Standardized Levels of Performance of the set may require to be adjusted to efficiently differentiate Levels of Performances Observed. Any adjustments must be done such that they are not subjected to interpretation. For example, a Standardized Norm of Performance such as “Usually operates production lines” could be adjusted to introduce a smaller differentiating increment like—USUALLY operates “all” production lines—or —USUALLY operates “at least 6” production lines—.

A third reason is to recognize the continuous improvement of the members of the organization, i.e. those subjected to the job factor for which the scale needs to be calibrated. When the organization succeeds in improving the performance of many of its employees to or near the Highest Standardized Level of Performance, the time has come to consider re-calibrating the job factor scale to make it more challenging, e.g. by adding an additional Standardized Norm of Performance or an additional Standardized Level of Performance above the current Highest Standardized Level of Performance. Such job factor maintenance provides best performers with room to grow and continuing opportunities to improve their performances.

In the exemplary embodiment, referring now to FIG. 7B1 (Top) and (Bottom), there is shown screenshot 720 of FIG. 7 before the calibration stage. In the exemplary embodiment, with respect to the 21 Standardized Levels of Performance displayed 720, each line of section 720 below the column titles corresponds to a Standardized Level of Performance. Each Standardized Level of Performance may be referred to by a unique performance level number 721. The text expression of the Standardized Level of Performance is in the area called “Performance standards to calibrate” 722. During the calibration step, the column titled “Ratees” 723 is used to record the number of employees that has been judged to perform at the level described by the corresponding Standardized Level of Performance following Step Rating Scale rating rules 1 and 2. Still during the calibration step, the column titled “Keep?” 724 is used to select, based on Standardized Level of Performance 722—content, position and number of ratees—, which individual Standardized Levels of Performance 722 are to be retained for the job factor. The entry mechanism 724 could be, by way of non-limiting example, a series of option buttons. By default, all Standardized Levels of Performance 722 automatically generated are selected. Elements of FIG. 7B2 (Top) and (Bottom) and of FIG. 7B3 that are similar to elements in FIG. 7B1 (Top) and (Bottom) are identically labeled and a detailed description thereof is omitted.

For a Step Rating Scale to be an appropriate measuring instrument, it usually has to be calibrated. Calibrating is an iterative process. Those knowledgeable in the art will recognize that many calibration techniques may be applied. In the exemplary embodiment, the calibration step assumes that (a) a representative group of employees for which the job factor applies, has been identified, (b) their respective managers are knowledgeable of the Level of Performance Observed of each one in that group of employees, (c) managers have been trained and are knowledgeable in performing Levels of Performances Observed measurements with a Step Rating Scale, and (d) the performance evaluation system designer has the technical knowledge and experience of customizing Standardized Levels of Performance and structuring Step Rating Scales.

During the Step Rating Scale calibration, any of the twenty-one Standardized Levels of Performance 722 may be retained. Firstly, each manager evaluates his respective employees. Secondly, the number of employees rated per Standardized Level of Performance 722 is aggregated and then entered in column 723. Thirdly, if needed to improve the differentiation of ratees among Standardized Levels of Performance 722, some Standardized Levels of Performance adjustments could take place to make some Standardized Norms of Performance text expressions more specific resulting in better-differentiated Standardized Levels of Performance. Fourthly, Standardized Levels of Performance that are judged unnecessary to differentiate Levels of Performances Observed, to establish appropriate improvement goals or to improve rating efficiency, should be unselected 724. For example, any Standardized Levels of Performance under the lowest Level of Performance Observed in the group of employees are candidates to be unselected. The same could be said about Standardized Levels of Performance way above the highest Level of Performance Observed in the group of employees because over the next evaluation period, such Standardized Levels of Performance may be too out of reach. Fifthly, to have a better look at how would look the calibrated Step Rating Scale, by selecting the command button “Filter” 726 the performance evaluation system designer may filter the set of Standardized Levels of Performance 722 to display only those retained 724 for the job factor creation. At any stage, another calibration iteration may be performed. At any time, the Standardized Levels of Performance set 722 may be displayed by selecting the command button “Show All” 727. At the end of the calibration step, when participants are satisfied by (a) the degree of Levels of Performances Observed differentiation, (b) the smoothness of transition from one Standardized Level of Performance to the next, (c) the capacity to establish appropriate individual improvement goals and (d) the rating efficiency, selected Standardized Levels of Performance may be saved. By selecting the command button “Save” 728, system 100 generates the new job factor and stores it 328 in the performance evaluation system database 105.

In the exemplary embodiment, Algorithm 1 of system 100, generates a set of Standardized Levels of Performance 722 that combines Standardized Norms of Performance with “AND” Boolean operators. Adding a Standardized Norm of Performance with an “AND” Boolean operator to a Standardized Level of Performance, increases the degree of difficulty of the later. During calibration, the degree of difficulty of a Standardized Level of Performance can be relaxed by replacing an “AND” by an “OR” Boolean operator.

In the exemplary embodiment, referring now to FIG. 7B2 (Top) and (Bottom), there is shown screenshot 740 of FIG. 7 during the calibration stage. The designer has recorded the aggregated number of employees rated per Standardized Level of Performance in the “Ratees” column 723, and Standardized Levels of Performance have been selected to be retained in the calibrated Step Rating Scale. For example, even if no Levels of Performances Observed qualified to be rated at the Standardized Level of Performance PL#16 742, that Standardized Level of Performance has been selected as one of the scale anchors because it would make an appropriate difficult yet achievable individual goal for the employee that exhibited the Level of Performance Observedf rated at the Standardized Level of Performance PL#15 743. In still another example, even if no Levels of Performances Observed qualified to be rated at the Standardized Level of Performance PL#18 741, that Standardized Level of Performance has been selected such that it be utilized to show the direction to be taken by employees seeking to improve themselves.

In the exemplary embodiment, referring now to FIG. 7B3, there is shown screenshot 760 of FIG. 7 after the calibration of the scale is completed, where the filtered selection of the nine individual Standardized Levels of Performance (PL#18, 16, 15, 14, 13, 12, 11, 10 and 1) kept for the job factor to create is shown, ready to be saved. By selecting the command button “Save” 728, system 100 proceeds to generate the new job factor and stores it 328 in the performance evaluation system database 105.

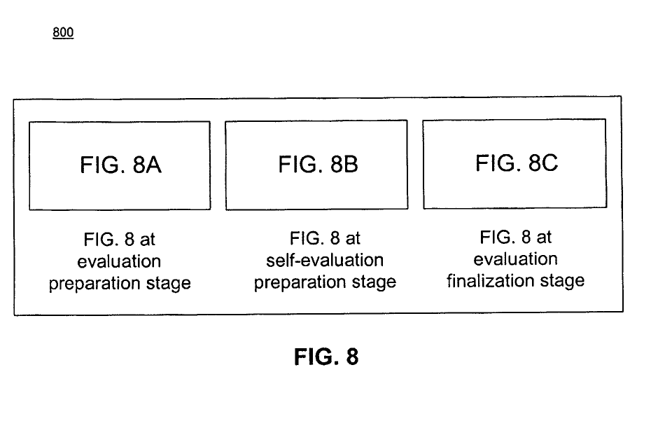

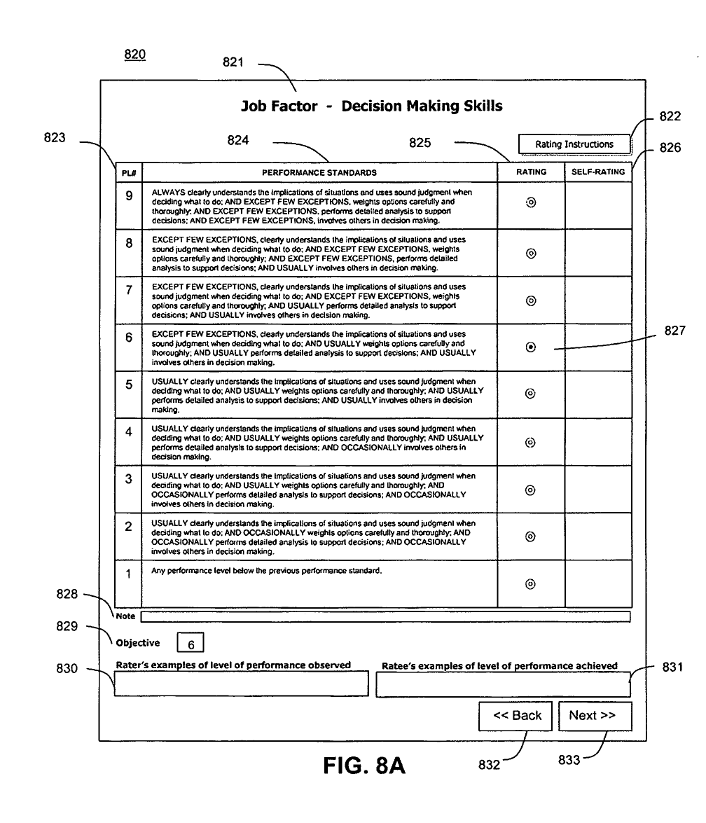

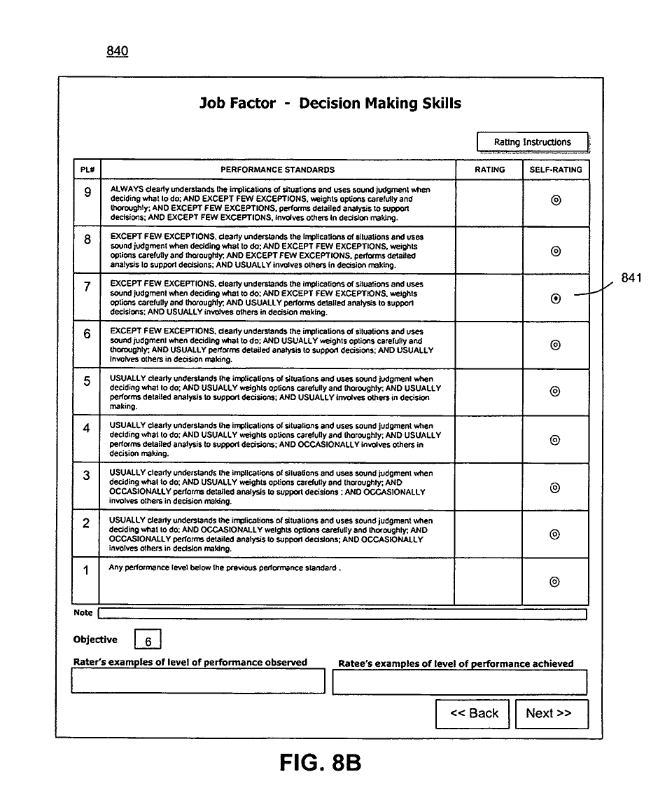

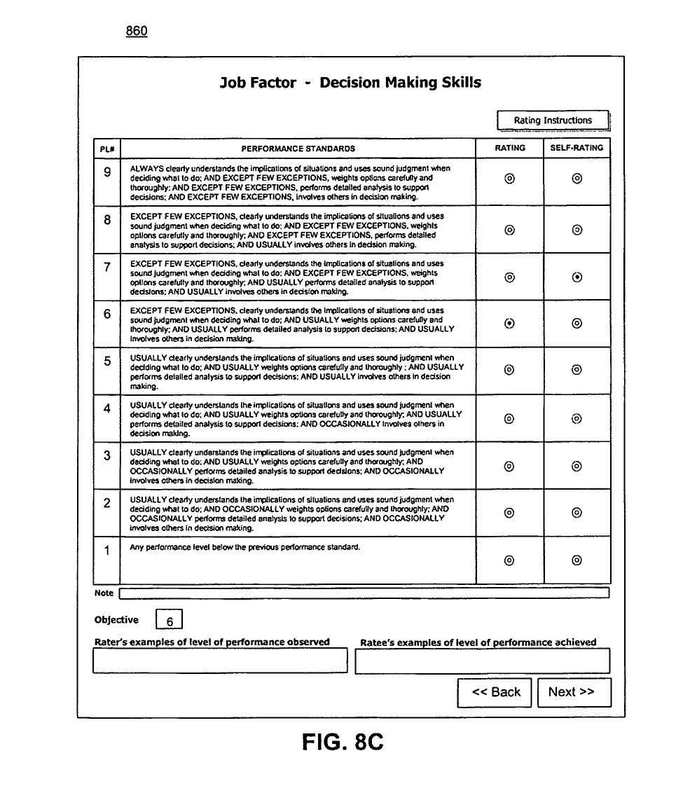

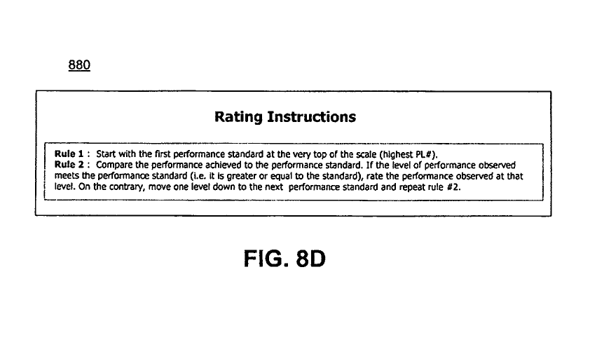

In the exemplary embodiment, referring now to FIG. 8 there is shown a block diagram of the job factor “Decision Making Skills”, at different evaluation stages, with which rater and ratee provide their rating and self-rating to system 100. It is assumed that the first part of the evaluation form, that incorporates this job factor, comprises employee and manager identifications, job identification and document status information. Referring now to FIG. 8A, there is shown screenshot 820 of FIG. 8 at evaluation preparation stage 421. The job factor of FIG. 8 comprises a job factor title 821. It may also comprise rating instructions or a command button 822 to access them. It comprises a 9-Standardized Level of Performance Step Rating Scale with the quantifier set “AEUOR” 824. It also comprises performance level numbers 823 in decreasing order, corresponding to Standardized Levels of Performance 824, used to quantify and identify individual Standardized Level of Performance. With respect to rating employees Levels of Performances Observed, an entry mechanism 825 such as, by way of non-limiting example, a series of option buttons for recording rating is used. With respect to employees self-rating, an entry mechanism 826 such as, by way of non-limiting example, a series of option buttons for recording self-rating is used. When a rater accesses the evaluation results data module 104 to prepare his evaluations 421, the self-rating selection 826 is not displayed to avoid influencing the rater. Similarly, when a ratee accesses the evaluation results data module 104 to prepare his self-evaluation 481, the rating selection 825 is not displayed to avoid influencing the ratee. The job factor 820 may also comprise a clarification note 828, if additional information has been communicated to system 100 through the entry mechanism 707. It may also comprise an entry mechanism 829 for displaying an automatically generated personalized goal and/or for entering such goal for each employee. In addition, it may also comprise entry mechanisms 830-831 for rater to document the Level of Performance Observed, e.g. detailed examples of Level of Performance Observed supporting the rational for selecting one Standardized Level of Performance from another, i.e. why the rating is not one Standardized Level of Performance up or down, and for the ratee to document his level of performance achieved. When a rater accesses the evaluation results data module 104 to prepare his evaluations 421, the content of the entry mechanism 831 is not displayed to avoid influencing the rater. Similarly, when a ratee accesses the evaluation results data module 104 to prepare his self-evaluation 481, content of the entry mechanism 830 is not displayed to avoid influencing the ratee. Command buttons “Back” 832 and “Next” 833 may be used to navigate through the evaluation form. Elements of FIGS. 8B and 8C that are similar to elements in FIG. 8A are identically labeled and a detailed description thereof is omitted.

In the exemplary embodiment, still referring to FIG. 8A, the rater view 820 shows the rating recorded PL#6 827 and hides the self-rating recorded PL#7 841. To rate an employee Level of Performance Observed, the rater reads the note 828 if present, follows rating instructions 822, records his evaluation by selecting the appropriate option button 825, and he may add comments 830 to the job factor. He then proceeds to the next job factor to evaluate through the navigation buttons 832-833. The access to entry mechanisms 825 and 830 may be controlled by the performance evaluation system administrator.

In the exemplary embodiment, referring now to FIG. 8B, there is shown screenshot of the ratee view 840 of FIG. 8 at self-evaluation preparation stage 481 where the self-rating recorded 841 is shown hides the rating recorded 827 is hidden. Similarly to the rater, self-rating requires the ratee to read note 828 if present, to follow evaluation instructions 822, to record his self-evaluation by selecting the appropriate option button 826, and he may add comments 831 to the job factor. He then proceeds to the next job factor to self-evaluate through the navigation buttons 832-833. The access to entry mechanisms 826 and 831 may be controlled by the performance evaluation system administrator.

In the exemplary embodiment, referring now to FIG. 8C, there is shown a screenshot of the shared view 860 of FIG. 8 at evaluation finalization stage 422 where both rating 827 and self-rating 841 recorded are shown. The shared view 860 is only accessed during a formal meeting review 422 which shows both rating 827 and self-rating 841 recorded as well as both rater 830 and ratee 831 comments. To load the employee evaluation form 463, the employee must communicate to system 100 his user ID and password 462. The meeting participants may then proceed with a formal review of ratings and self-ratings 464 through discussions as well as exchange of points of view, written comments and observations. Following those exchanges, either participant has the opportunity to revise their rating and self-rating 465. When all job factors have been revised, revised ratings and revised self-ratings may be saved and communicated to system 100 to be stored 466 in performance evaluation system database 105.

A performance evaluation system according to the present invention may also comprise computer-automated steps to generate rating quality control reports 504, for example, flagging instances where rating manipulations are suspected and communicating quality control indicators status. There is many ways to compute quality control indicators. For example, an indicator may be defined as the absolute value of the difference between a revised rating and a revised self-rating. Obviously, this assumes that employees perform self-evaluations. Suspicious values may be defined as those greater or equal to a certain threshold 505 under the control of the performance evaluation system administrator.

When evaluations are completed but before processing ratings 503, rating quality control reports could be run by the performance evaluation system administrator to verify the possibility of rating errors like halo and leniency, and of rating manipulations. Potential instances flagged by system 100 may therefore be investigated prior to processing ratings 503. By doing so, the performance evaluation system administrator adds fairness to the evaluation process and contributes to reduce or avoid the manipulation of ratings.

A performance evaluation system according to the present invention may comprise other computer automated steps for managing system and technical components of a performance evaluation system. Referring now to FIG. 3, there is shown a flowchart of an exemplary evaluation design data module 103 process 300 that may be used to create a job factor 301, already discussed, to modify or delete a job factor 302, to create a new evaluation form 303, to modify or delete an evaluation form 304, and to setup system parameters 305.

Referring now to FIG. 3B, there is shown a flowchart extension of FIG. 3 that shows an exemplary process 340 that may be used to modify or delete a job factor. The performance evaluation system designer may access a computer screen that enables him, through menus or hyperlinks, to access menu 302, to fetch from the performance evaluation system database 105 the job factor 341, to delete it 343, or to modify it and recalibrate it 342, if required. Through link “E”, the flowchart continues to task 328 previously discussed.

Referring now to FIG. 3C, there is shown a flowchart extension of FIG. 3 that shows an exemplary process 360 that may be used to create a new evaluation form. Firstly, the key job dimensions must be established. This may be done in participation with some employees, with managers responsible for those jobs and with other individuals who may contribute to the analysis of the job, e.g. description, requirements, contribution to the organization, metrics, etc. Secondly, the performance evaluation system designer may access a computer screen that enables him, through menus or hyperlinks, to access menu 303, to identify in the performance evaluation system database 105 existing job factors corresponding to key job dimensions and those to create 362. Any key job dimension must have a corresponding job factor stored in the performance evaluation system database 105. For any key job dimension that does not have a corresponding job factor stored in the performance evaluation system database 105, a job factor must be created as indicated by flowchart link “A” to menu 301, previously discussed. Thirdly, the performance evaluation system designer selects and loads from the performance evaluation system database 105 all job factors corresponding to key job dimensions 363. Fourthly, the performance evaluation system designer establishes the job factors sequence in the evaluation form 364. Fifthly, he establishes their relative weights 365. Through link “E”, the flowchart continues to task 328, previously discussed.

Referring now to FIG. 3D, there is shown a flowchart extension of FIG. 3 that shows an exemplary process 380 that may be used to delete or modify an evaluation form. The performance evaluation system designer may access a computer screen that enables him, through menus or hyperlinks, to access menu 304, to fetch from the performance evaluation system database 105 the evaluation form 381, to delete it 385, or to modify the selection of job factors 382. After having modified the selection of job factors, the performance evaluation system designer may modify their sequence 383 and their weighs 384. Through link “E”, the flowchart continues to task 328, previously discussed.

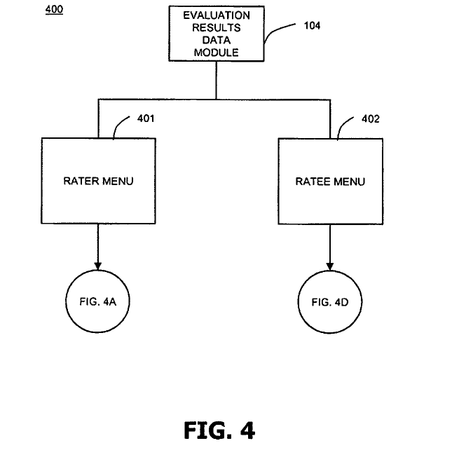

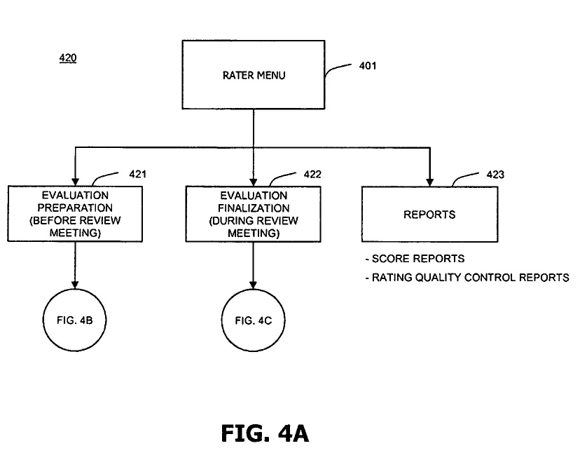

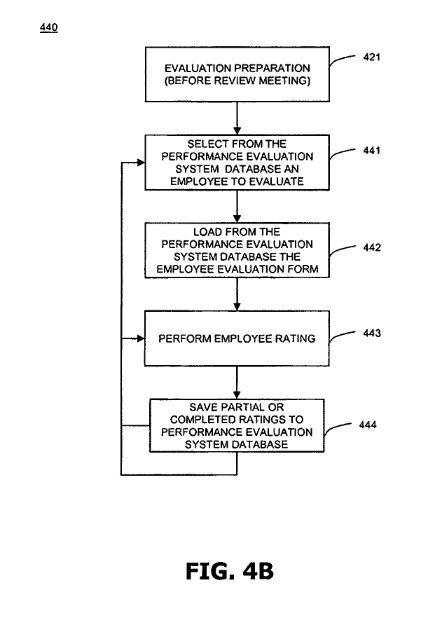

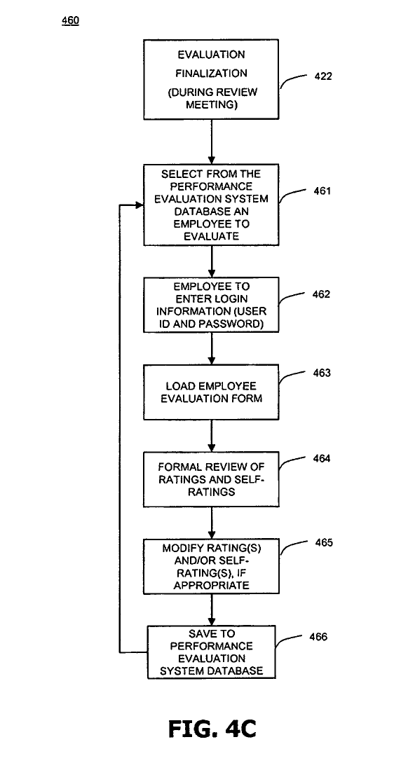

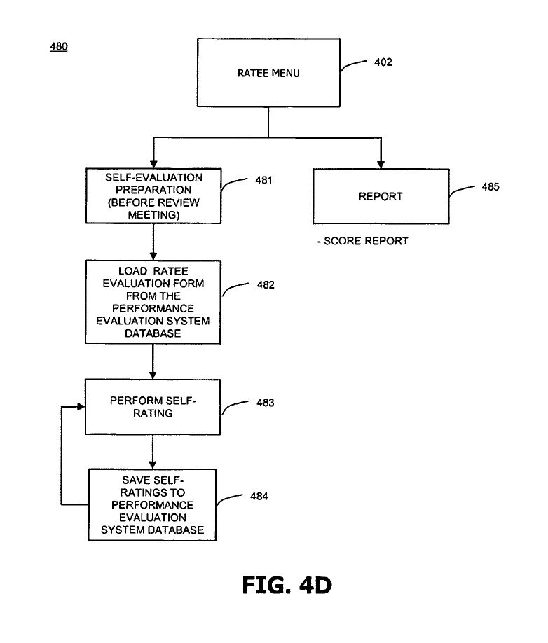

A performance evaluation system according to the present invention may comprise other computer automated steps for performing evaluations and self-evaluations. Referring now to FIG. 4, there is shown a flowchart of an exemplary evaluation results data module 104 process 400 that may be used by raters to perform evaluations 401 and by ratees to perform self-evaluations 402.

Referring now to FIG. 4A, there is shown a flowchart extension of FIG. 4 that shows an exemplary process 420 that may be used to perform an evaluation as part of a rater preparation for the review meeting with the employee 421. It may also be used to revise and finalize ratings and the employee to revise and finalize his self-ratings, if applicable, during the formal review meeting with the employee 422. It may also be used to view/print reports 423 like scores reports and rating quality control reports, if access has been granted by the performance evaluation system administrator.

Referring now to FIG. 4B, there is shown a flowchart extension of FIG. 4 that shows an exemplary process 440 that may be used to perform an evaluation as part of a rater preparation for the review meeting with the employee 421. The rater may access a computer screen that enables him, through menus or hyperlinks, to access menu 421, to select from the performance evaluation system database 105 one of his employees to evaluate 441, to load from the performance evaluation system database 105 the employee evaluation form 442, to rate the employee 443, to save partial or completed ratings 444 to the performance evaluation system database 105, to repeat steps 443-444 until the evaluation is completed or to repeat steps 441-444 for another employee.

Referring now to FIG. 4C, there is shown a flowchart extension of FIG. 4 that shows an exemplary process 460 that may be used to revise and finalize ratings and the employee to revise and finalize his self-ratings, if applicable, during the formal review meeting 422. The rater may access a computer screen that enables him, through menus or hyperlinks, to access menu 422, to select from the performance evaluation system database 105 the employee being reviewed 461, to let the employee enter his user login information, user ID and password 462, to load the employee evaluation form with full display of ratings and self-ratings 463, to perform a revision of each rating and self-rating for each participant 464, to modify rating and/or self-rating 465, to save revised ratings and revised self-ratings 466 to the performance evaluation system database 105, and to repeat steps 461-466 for another employee. In a meta-analytic review, Cawley [1998:618], referring to many authors, wrote “The idea of allowing individuals who are affected by a decision to present information that they consider relevant to the decision is known in the justice literature as voice. Research has shown that voice may lead to perceptions of procedural justice as well as to positive reactions such as satisfaction and perceptions of fairness”. A Step Rating Scale based job factor supports the preference to discuss the Level of Performance Observed, judgments and ratings before their submission to system 100.

Referring now to FIG. 4D, there is shown a flowchart extension of FIG. 4 that shows an exemplary process 480 that may be used to perform a self-evaluation as part of a ratee preparation for the review meeting with his supervisor 481. It may also be used to view/print reports 485, if access has been granted by the performance evaluation system administrator.

Still referring to FIG. 4D, the ratee may access a computer screen that enables him, through menus or hyperlinks, to access menu 481, to load from the performance evaluation system database 105, his evaluation form 482, to self-rate 483, to save partial or completed self-ratings 484 to the performance evaluation system database 105, and to go back to repeat steps 483-484 until his self-evaluation is completed.

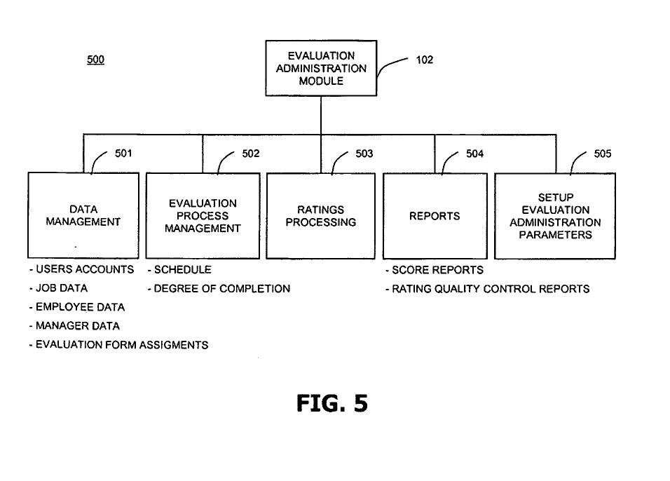

A performance evaluation system according to the present invention may also comprise computer automated steps for administrating the performance evaluation system. Referring now to FIG. 5, there is shown a flowchart of an exemplary evaluation administration module 102 process 500 that may be used by a performance evaluation system administrator to manage performance evaluation system data (users accounts, job data, employee data, manager data, evaluation form data, etc) 501, to manage the organization evaluation process (process schedule, degree of completion) 502, to process ratings 503, to report on performance evaluation issues (ratings, scores, rating quality control, etc) 504, and to setup performance evaluation system administration parameters 505.

Different organizations may adopt different processes and value different criteria for evaluating employee performance. For example, in some organizations, performance standards are based around organizational-wide competency clusters such as, by way of non-limiting example, an employee's customer focus and people focus. These competency clusters are further broken down into descriptions of specific behaviors and detailed competencies, and employees are assessed on how well they have demonstrated these. Alternatively, an organization may want to differentiate employee performance. For such an evaluation, employees' overall score may be input into the organization merit-pay compensation system to determine fair salary increases. Yet other organizations may want to assess each employee's proficiency across a number of technical, business or interpersonal skills. An assessment of this nature may be used to identify skill/talent shortfalls in the organization and to effectively plan training, development, and hiring decisions around both current and future skill-set requirements.

An organization may use system 100 to create Step Rating Scale based job factors that uses other quantifier sets than “AEUOR”. In the exemplary embodiment, referring now to FIG. 9, there is shown a screenshot of a “Job Knowledge” job factor that may be used to evaluate a knowledge-based competence 900. This job factor may be used by a rater and a ratee to provide respectively a rating and a self-rating to system 100. Elements of FIG. 9 that are similar to elements in FIG. 8A are identically labeled and a detailed description thereof is omitted.

Still referring to FIG. 9, the job factor is based on an 8-Standardized Level of Performance Step Rating Scale with the quantifier set “AAMF”, where the text expressions of Standardized Norms of Performance describe observable “knowledge” and “experience” norms. To create such job factor, the performance evaluation system designer followed the process 320 where the series of tasks 321, 324, 325 and 328 were performed. The quantifier set labeled “AAMF” comprises the quantitative qualifiers “All”, “Almost all”, “Most” and “Few”. An analogy can be made between the quantifier sets “AEUOR” and “AAMF” where “All” is analog to “Always”, “Almost all” is analog to “Except few exceptions”, “Most” is analog to “Usually” and “Few” is analog to “Rarely”. Nothing in the quantifier set “AAMF” corresponds to the quantifier “Occasionally”. Obviously, when you possess certain knowledge or experience, it is a permanent condition, not an occasional one. In this exemplary embodiment, the wizard 325 is slightly different than wizard 323. For example, the counter part of Algorithm 1 (wizard 323) in wizard 325 combines knowledge-based competence text expressions with quantifiers differently. In effect, to read Standardized Norms of Performance properly, quantifiers from the quantifier set “AAMF” are inserted after the verb of the knowledge-based competence text expression. Those knowledgeable in the art will recognize that system 100 may apply the Step Rating Scale method in different ways by configuring the quantifier set and the constructed statements with appropriate algorithms 324-325. This way, system 100 performs as a design and assessment engine that may be tailored to suit different design criteria and assessment processes.

Those knowledgeable in the art, will recognize that in addition to behavioral and competency job factors, the Step Rating Scale method of system 100 may also be applied to Management By Objective job factors. Management By Objective (MBO), introduced by Peter Drucker in 1954, has evolved to take, in practice, a variety of formats. They usually shared setting objectives in terms of quantity, of quality, of time and costs. These dimensions become the norms that enable a rater to judge if the results achieved, i.e. the Level of Performance Observed, satisfy the objective or not. Traditionally, each norm describing the objective must be achieved to judge the objective achieved. With the exception of quality that may be described in qualitative terms, norms are usually of a quantitative nature. If intuitively a Management By Objective job factor may appear to be a more objective instrument, it is not always the case. A high degree of ambiguity often is present, for example, when a rater must judge results where only some norms were achieved.

In cases of Management By Objective job factors, depending on the nature of the objective, i.e. depending on the nature of what has to be delivered, a project, a plan, an equipment, a cost reduction, etc, key dimensions of the objective are taken into account by system 100 when the user, performance evaluation system designer or a manager, selects the appropriate Management By Objective job factor format 321. Standardized Levels of Performance are constructed from Standardized Norms of Performance corresponding to the key dimensions associated with the objective, e.g. norms of quantity, of quality, of time and costs. Depending on the number of levels in the Step Rating Scale as well as the type of norms to be used to judge the results achieved, different design wizards 324-325 are used.

Still in cases of Management By Objective job factors, the Step Rating Scale design wizards 324-325 utilize pre-programmed components of Standardized Norms of Performance. Depending on the norm itself, the quantifier and/or the norm text-expression may be pre-programmed. Any additional information required by design wizards 324-325 is provided by the user.

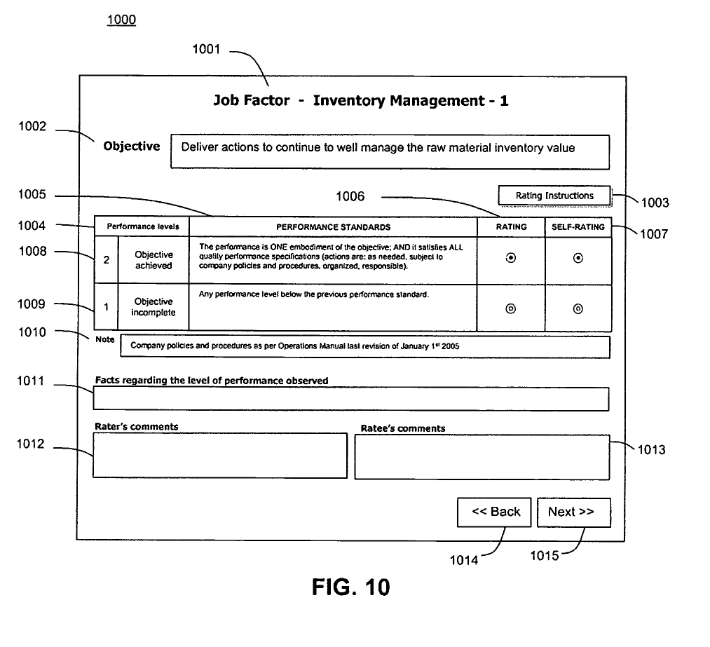

In the exemplary embodiment, referring now to FIGS. 10, 11, 12 and 13, there is shown screenshots of Management By Objective job factors who share a set of pre-programmed Standardized Norms of Performance called the “MBO-Standardized Norms of Performance” set. Before introducing each figure, let us look through FIG. 10 to 13 to review some elements of the MBO-Standardized Norms of Performance set.

Referring now to FIG. 10 Highest Standardized Level of Performance 1008, there is the first Standardized Norm of Performance “The performance is ONE embodiment of the objective”, i.e. the result delivered is a valid embodiment of the objective to achieve. Because this “Embodiment” MBO-Standardized Norm of Performance is generic to any Management By Objective job factor, it is automatically generated by Management By Objective factor wizards 324-325 of system 100, and added to all Standardized Levels of Performance but the Lowest Standardized Level of Performance. Thus, the quantifier of the Standardized Norm of Performance is the text-expression “ONE”, i.e., “1”. The second component of the Standardized Norm of Performance, the external, i.e. observable, component, is the text-expression “The performance is . . . embodiment of the objective”. With prior art Management By Objective job factors, this norm is rarely explicitly written down but doing so specifies the nature of the expected result. For this job factor, a valid embodiment would be, for example, a “list of tasks and/or activities performed to manage the raw material inventory value”.

Referring now to FIG. 10 Highest Standardized Level of Performance 1008 second Standardized Norm of Performance “It satisfies ALL quality performance specifications (actions are: as needed, subject to company policies and procedures, organized, responsible)” i.e. “how” the performance must be delivered. To create a “Quality performance specifications” MBO-Standardized Norm of Performance, the wizard 325 of system 100 does the following automatically. It uses the quantifier “ALL” and the pre-programmed text-expression “It satisfies . . . quality performance specifications ([ . . . ])”, it inserts the quantifier in the text-expression, and it inserts the text-expression of the personalized specifications provided by the user between the square brackets. If a “Quality performance specifications” MBO-Standardized Norm of Performance is used by more than a single Standardized Level of Performance, the user must provide a text-expression of the personalized specifications for each Standardized Level of Performance.

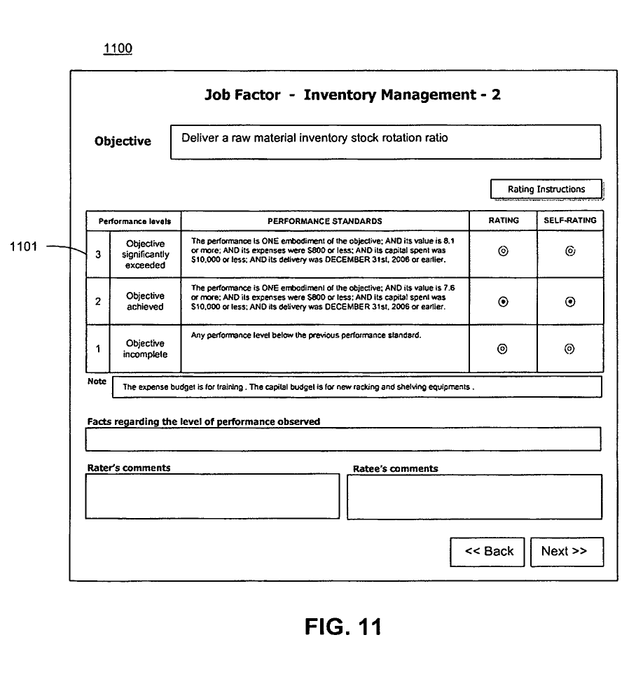

Referring now to FIG. 11 Highest Standardized Level of Performance 1101 second Standardized Norm of Performance “Its value is 8.1 or more”. To create a “Value” MBO-Standardized Norm of Performance, the wizard 325 of system 100 does the following automatically. It uses the quantifier “8.1” provided by the user, it uses the pre-programmed text-expression “Its value is [ . . . ] or more”, it inserts the quantifier into the pre-programmed text-expression between the square brackets. The term value means the numerical value of the objective. For a “Value” MBO-Standardized Norm of Performance, the wizard 325 may offer other pre-programmed text expressions like “Its value is equal to [ . . . ]” or “Its value is more than [ . . . ]”. If a “Value” MBO-Standardized Norm of Performance is used by more than a single Standardized Level of Performance, the user must provide a, possibly different, quantifier and a, possibly different, pre-programmed text expression, for each Standardized Level of Performance.

Referring now to FIG. 11 Highest Standardized Level of Performance 1101 third Standardized Norm of Performance “Its expenses were $800 or less”. To create an “Expense” MBO-Standardized Norm of Performance, the wizard 325 of system 100 does the following automatically. It uses the quantifier “$800” provided by the user, it uses the pre-programmed text-expression “Its expenses were [ . . . ] or less”, it inserts the quantifier into the pre-programmed text-expression between the square brackets. For an “Expense” MBO-Standardized Norm of Performance, the wizard 325 may offer other pre-programmed text expressions like “Its expenses were equal to [ . . . ]” or “Its expenses were less than [ . . . ]”. If an “Expense” MBO-Standardized Norm of Performance is used by more than a single Standardized Level of Performance, the user must provide a, possibly different, quantifier and a, possibly different, pre-programmed text expression, for each Standardized Level of Performance.

Referring now to FIG. 11 Highest Standardized Level of Performance 1101 fourth Standardized Norm of Performance “Its capital spent was $10,000 or less”. To create a “Capital Expenditure” MBO-Standardized Norm of Performance, the wizard 325 of system 100 does the following automatically. It uses the quantifier “$10,000” provided by the user, it uses the pre-programmed text-expression “Its capital spent was [ . . . ] or less”, and it inserts the quantifier into the pre-programmed text-expression between the square brackets. For a “Capital Expenditure” MBO-Standardized Norm of Performance, the wizard 325 may offer other pre-programmed text expressions like “Its capital spent was equal to [ . . . ]” or “Its capital spent was less than [ . . . ]”. If a “Capital Expenditure” MBO-Standardized Norm of Performance is used by more than a single Standardized Level of Performance, the user must provide a, possibly different, quantifier and a, possibly different, pre-programmed text expression, for each Standardized Level of Performance.

Referring now to FIG. 11 Highest Standardized Level of Performance 1101 fifth Standardized Norm of Performance “Its deadline was Dec. 31, 2006 or earlier”. To create a “Deadline” MBO-Standardized Norm of Performance, the wizard 325 of system 100 does the following automatically. It uses the quantifier “Dec. 31, 2006”, i.e. a date, provided by the user, it uses the pre-programmed text-expression “Its deadline was [ . . . ] or earlier”, and it inserts the quantifier into the pre-programmed text-expression between the square brackets. For a “Deadline” MBO-Standardized Norm of Performance, the wizard 325 may offer other pre-programmed text expressions like for example “Its deadline was [ . . . ]”. If a “Deadline” MBO-Standardized Norm of Performance is used by more than a single Standardized Level of Performance, the user must provide a, possibly different, quantifier and a, possibly different, pre-programmed text expression, for each Standardized Level of Performance.

Those knowledgeable in the art, will recognize that system 100 may apply the Step Rating Scale method to Management By Objective job factors in different ways by configuring appropriate Management By Objective job factor design wizards for different performance dimensions like, for example, quantity delivered, quality of performance, efficiency, etc.

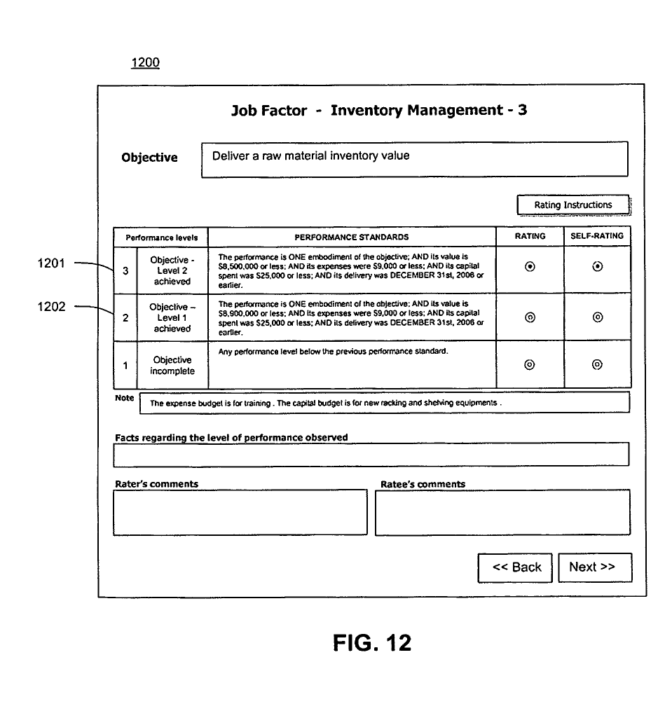

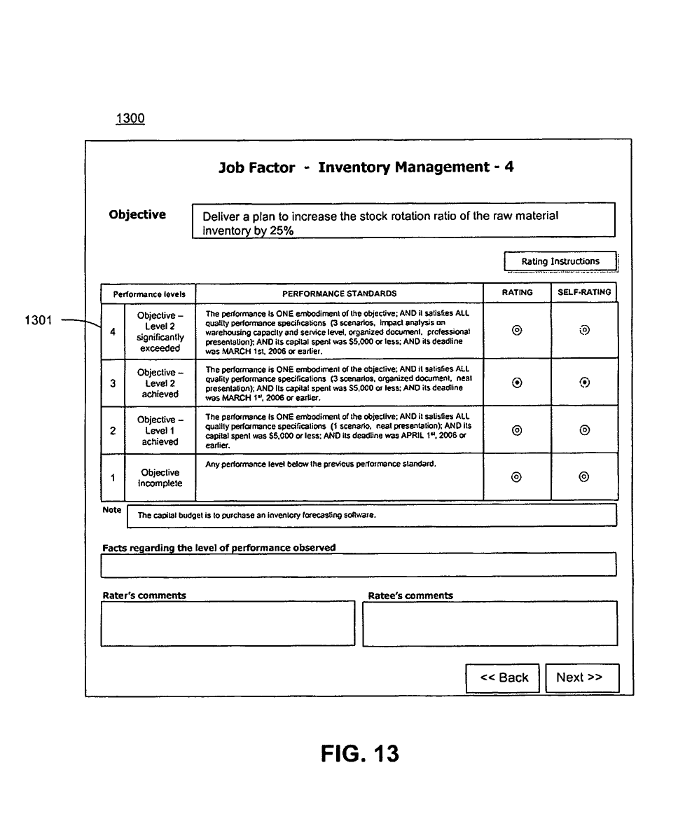

In the exemplary embodiment, referring now to FIG. 10, there is shown a screenshot of the job factor titled “Inventory Management-1” 1000 based on an 2-Standardized Level of Performance Step Rating Scale used to evaluate the achievement of an objective, i.e. the Level of Performance Observed, in a context of Management By Objective. The job factor may be part of a job evaluation form, through which rater and ratee may provide their rating and self-rating to system 100. The job factor 1000 comprises a job factor title 1001 and a description of the objective 1002. It may also comprise rating instructions directly on the job factor or a rating instructions button 1003 that opens a window similar to FIG. 8D. It comprises a 2-Standardized Level of Performance Step Rating Scale 1005 with performance level numbers 1004, in decreasing order, corresponding to Standardized Levels of Performance 1005 where Standardized Levels of Performance describe levels of achievement of the objective. With respect to rating the performance delivered by an employee, an entry mechanism 1006 such as, by way of non-limiting example, a series of option buttons for entering rating is used. Because job factor 1000 is a Management By Objective Step Rating Scale type of format, its 2-Standardized Level of Performance structure is specifically defined. This means that the number of Standardized Levels of Performance is predetermined and cannot be changed by the user. The Highest Standardized Level of Performance 1008, i.e. Performance level #2, is labeled “Objective achieved”. The Lowest Standardized Level of Performance 1009, i.e. Performance level #1, is labeled “Objective incomplete”. The scale is bounded at the Highest Standardized Level of Performance and unbounded at the Lowest Standardized Level of Performance. With such Management By Objective type of format, an objective is either met or not. This format is usually preferred when there is no intention to differentiate different levels of achievement including over achieving the objective. It recognizes achieving an objective and communicates as well that overachieving it is not sought. With respect to employees self-rating, an entry mechanism 1007 such as, by way of non-limiting example, a series of option buttons for entering rating is used. When a rater accesses the evaluation results data module 104 to prepare his evaluations 421, the self-rating selection 1007 is not displayed to avoid influencing the rater. Similarly, when a ratee accesses the evaluation results data module 104 to prepare his self-evaluation 481, the rating selection 1006 is not displayed to avoid influencing the ratee. The job factor 1000 may also comprise a clarification note 1010. It may also comprise a text field 1011 to document the Level of Performance Observed with facts. In addition, it may also comprise text fields 1012-1013 for rater and ratee to document the rational for selecting one Standardized Level of Performance from another, i.e. why the rating/self-rating is not one Standardized Level of Performance up or down. When a rater accesses the evaluation results data module 104 to prepare his evaluations 421, the content of the text field 1013 is not displayed to avoid influencing the rater. Similarly, when a ratee accesses the evaluation results data module 104 to prepare his self-evaluation 481, content of the text field 1012 is not displayed to avoid influencing the ratee. Command buttons “Back” 1014 and “Next” 1015 may be used to navigate through the evaluation form. Elements of FIG. 11, FIG. 12 and FIG. 13 that are similar to elements in job factor screenshot 1000 of FIG. 10 are identically labeled and a detailed description thereof is omitted.

Because of the high degree of ambiguity often present when a rater must judge results where only some norms were achieved, a performance evaluation system according to the present invention may comprise Management By Objective job factors to evaluate multi-level objectives. A single level objective corresponds to a single Standardized Level of Performance expected to be reached. A multi-level objective corresponds to multiple levels of achievement, e.g. level 1, 2, etc, each described by a different Standardized Level of Performance. A multi-level objective approach could be used to recognize the value of different level of performances. Consider a 2-level objective, where level 2 is the highest level of performance achieved. For example, the “Deadline” MBO-Standardized Norm of Performance of the Standardized Level of Performance describing “Objective-Level 2” could be set one quarter earlier than in “Objective-Level 1”. In another example, the “Expense” MBO-Standardized Norm of Performance of the Standardized Level of Performance describing “Objective-Level 2” could be set twenty five percent lesser than “Objective-Level 1”.

In the exemplary embodiment, referring now to FIG. 11, there is shown a screenshot of the job factor titled “Inventory Management-2” 1100 based on an 3-Standardized Level of Performance Step Rating Scale used to evaluate the achievement of an objective, i.e. the Level of Performance Observed, in a context of Management By Objective. The job factor may also be part of a job evaluation form, through which rater and ratee may provide their rating and self-rating to system 100. Because job factor 1100 is a Management By Objective Step Rating Scale type of format, its 3-Standardized Level of Performance structure is specifically defined. The scale Highest Standardized Level of Performance 1101, i.e. Performance level #3, is labeled “Objective significantly exceeded”. For a description of the middle Standardized Level of Performance, refer to FIG. 10 Highest Standardized Level of Performance. For a description of the Lowest Standardized Level of Performance, refer to FIG. 10 Lowest Standardized Level of Performance. The scale is bounded at the Highest Standardized Level of Performance and unbounded at the Lowest Standardized Level of Performance. With such format, an objective is exceeded, met or missed. This format is usually preferred when there is an intention to differentiate exceeding the objective from achieving it. It can recognize achieving an objective and communicate as well that overachieving it is also sought, e.g. sales volume.

In the exemplary embodiment, referring now to FIG. 12, there is shown a screenshot of the job factor titled “Inventory Management-3” 1200 also based on an 3-Standardized Level of Performance Step Rating Scale used to evaluate the achievement of a 2-level objective, in a context of Management By Objective. The job factor may also be part of a job evaluation form, through which rater and ratee may provide their rating and self-rating to system 100. Because job factor 1200 is a Management By Objective Step Rating Scale type of format, its 3-Standardized Level of Performance structure is specifically defined. FIG. 12 shows a different 3-Standardized Level of Performance Step Rating Scale than FIG. 11. FIG. 12 introduces a different Highest Standardized Level of Performance 1201 labeled “Objective-Level 2 achieved” and a different middle Standardized Level of Performance 1202 labeled “Objective-Level 1 achieved”, than FIG. 11. For a description of the Lowest Standardized Level of Performance, refer to FIG. 10 Lowest Standardized Level of Performance. The scale is bounded at the Highest Standardized Level of Performance and unbounded at the Lowest Standardized Level of Performance. With such format, a 2-level objective is met at the second level, met at the first level or missed. This format is usually preferred when there is an intention to differentiate two levels of achievement. It may recognize achieving one of two levels of a 2-level objective and communicate as well that delivering a higher level of achievement is sought, but not exceeding it, e.g. Level 1 could represent the sales budget at 90% plant capacity, and Level 2 could be the one at 100% plant capacity.

In the exemplary embodiment, referring now to FIG. 13, there is shown a screenshot of the job factor titled “Inventory Management-4” 1300 based on an 4-Standardized Level of Performance Step Rating Scale used to evaluate the achievement of a 2-level objective, i.e. the Level of Performance Observed, in a context of Management By Objective. The job factor may also be part of a job evaluation form, through which rater and ratee may provide their rating and self-rating to system 100. Because job factor 1300 is a Management by Objective Step Rating Scale type of format, its 4-Standardized Level of Performance structure is specifically defined. The scale Highest Standardized Level of Performance 1301, i.e. Performance level #4, is labeled “Objective-Level 2 significantly exceeded”. For a description of Standardized Levels of Performance describing performance level #3 and #2, respectively refer to FIG. 12 Highest Standardized Level of Performance and middle Standardized Level of Performance. For a description of the Lowest Standardized Level of Performance, refer to FIG. 10 Lowest Standardized Level of Performance. The scale is bounded at the Highest Standardized Level of Performance and unbounded at the Lowest Standardized Level of Performance. With such format, a 2-level objective is exceeded, met at the second level, met at the first level or missed. This format is usually preferred when there is an intention to differentiate exceeding the objective from achieving one of its two levels of achievement. It can recognize achieving one of two levels of a 2-level objective and communicate as well that overachieving it is also sought, e.g. Level 1 could represent the sales volume budgeted, Level 2 could be the sales volume triggering a percentage of commission, and exceeding level 2 could trigger an incentive bonus.

In addition, those knowledgeable in the art, will recognize other applications where a Step Rating Scale may be used as an evaluation tool, by way of non-limiting example, in multi-raters, i.e. 360-degree, performance evaluation systems, in business applications to evaluate vendors, products, services, systems or board members; in human resources applications like recruiting or career planning to evaluate candidates; in marketing applications like focus group to evaluate products or publicity; in educational applications to evaluate students, teachers or trainers; and in other sectors of activity.

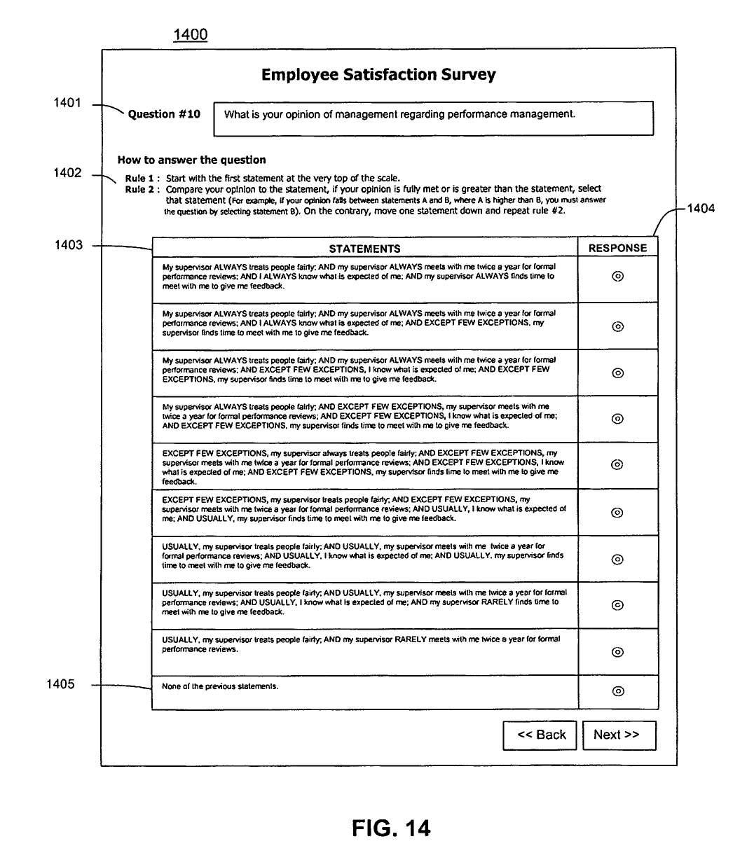

In addition to evaluating performance, an organization may use a system similar to system 100 to perform surveys. In another embodiment, referring now to FIG. 14, there is shown a screenshot of a topic being surveyed by an organization as part of an Employee Satisfaction survey. The screenshot of question #10 1400, or survey factor, is based on a 10-Standardized Level of Performance Step Rating Scale with the quantifier set “AEUOR”. It comprises a question area 1401, an instruction area for the Step Rating Scale answering (rating) method 1402, a Step Rating Scale 1403 with statements used as Standardized Levels of Performance, an entry mechanism 1404 to record the answer to the question, and an unbounded lower performance standard 1405. To create such survey factor with a system similar to system 100, the survey system designer could proceed through a process similar to process 321-324-325-328. To create a survey form with a system similar to system 100, the performance evaluation system designer could proceed through a process similar to process 360 where key job dimensions are replaced by key survey questions. For the employees to respond to a survey with a system similar to system 100, the employee could proceed through a process similar to process 442-443-444 where answers are saved to a survey system database similar to the performance evaluation system database 105. For the survey system administrator to process survey answers with a system similar to system 100, the survey system administrator could proceed through a process similar to process 503 where ratings are replaced by survey answers. Furthermore, in addition to using a system similar to system 100 to survey the employees of an organization, system 100 may be used to survey, by way of non-limiting example, customers, vendors, focus-group participants and stakeholders to other situations.

The invention may be implemented in digital electronic circuitry, computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

The invention may be implemented in one or more computer programs that are executable on a programmable system including at least one programmable processor coupled to received data and instructions from, and to transmit data and instructions to, a data storage device. Each computer program may be implemented in a high-level procedural or object-oriented programming language or in assembly or machine language if desired; and in any case, the language may be a compiled or interpreted language. Suitable processors comprise, by way of example, both general and special purpose microprocessors.

Computers 201-207, 220, 251-256 in a performance evaluation system may be connected to each other by one or more network interconnection technologies 210, 231-235, 240, 270. For example, dial-up lines, token-ring and/or wireless and/or Ethernet networks, T1 lines, asynchronous transfer mode links, wireless links, digital subscriber lines (DSL) and integrated service digital network (ISDN) connections may all be combined in the network 200. Other packet network and point-to-point interconnection technologies may also be used. Additionally, the functions associated with separate processing and database servers in the host 280 may be organized into an application system provider (ASP) or may be integrated into a single server system or may be partitioned among servers and database systems that may be distributed geographically.

Two embodiments of the present invention have been described. Nevertheless, it will be understood that various system modifications may be made without departing from the spirit and scope of the invention. For example, user computers 201-207 can comprise a personal computer executing an operating system such as Microsoft Windows™, Unix™, Apple MacOS™, Linux™, as well as software applications, such as a WEB browser. User computers 201-207 may also be terminal devices, a personal digital assistant type like Palm™-type or BlackBerry™-type, a computer WEB access device that adhere to a point-to-point or network communication protocol such as the Internet protocol. Other examples may comprise TV WEB browsers, terminals, game consoles with terminal or computer capabilities, and wireless access devices, such as 3-Com Palm VII organizer™. A client computer may comprise a processor, RAM and/or ROM memory, a display capability, an input device, a networking capability, and hard disk or other relatively permanent storage such as CD, DVD, USB sticks, or the like.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electro-magnetical signal.

What is claimed is:

1. A method for generating a rating scale to be used in an evaluation form, said method comprising:
A) providing a plurality of elements to rate;
B) providing a plurality of sets of qualifying quantifiers for quantifying said elements to rate;
C) associating at least one of said qualifying quantifiers to each of said plurality of elements to rate; and
D) automatically generating a plurality of rating levels, each comprising a combination of at least one said elements to rate with a corresponding qualifying quantifier from its associated set of qualifying quantifiers, to form said rating scale.

2. The method as claimed in claim 1, wherein said associating of said at least one of said qualifying quantifiers to each of said plurality of elements to rate further comprises combining each of said associated plurality of elements to rate using a logical operator.

3. The method as claimed in claim 1, further comprising removing at least one of the plurality of rating levels.

4. The method as claimed in claim 1, further comprising displaying the plurality of rating levels to a user.

5. The method as claimed in claim 1, wherein said plurality of qualifying quantifiers comprises at least on of “always”, “except few exceptions”, “usually”, “occasionally” and “rarely”.

6. The method as claimed in claim 1, wherein said plurality of qualifying quantifiers comprises at least one of “all”, “almost all”, “most” and “few”.

7. The method as claimed in claim 1, wherein said plurality of elements to rate is selected from the group consisting of: working skills, working knowledge, survey data and academic knowledge.

8. A method for performing an evaluation, said method comprising:
A) providing a plurality of elements to rate;
B) providing a plurality of sets of qualifying quantifiers for quantifying said elements to rate;
C) associating at least one of said qualifying quantifiers to each of said plurality of elements to rate;
D) automatically generating a plurality of rating levels, each comprising a combination of at least one said elements to rate with a corresponding qualifying quantifier from its associated set of qualifying quantifiers to form said rating scale;
E) displaying said generated plurality of rating levels to a user; and
F) selecting a rating level of said displayed generated plurality of rating levels to thereby perform said evaluation.

9. The method as claimed in claim 8, wherein said associating of said at least one of said qualifying quantifiers to each of said plurality of elements to rate further comprises combining each of said associated plurality of elements to rate using a logical operator.

10. The method as claimed in claim 8, wherein said selecting of said rating level is performed by a person to evaluate.

11. The method as claimed in claim 10, wherein said providing of said elements to rate is performed by a person evaluating said person to evaluate.

12. The method as claimed in claim 11, wherein said selecting of said rating level is further performed by said person evaluating said person to evaluate, further comprising displaying a difference between said selecting performed by said person to evaluate and said selecting performed by said person evaluating said person to evaluate.

13. The method as claimed in claim 8, wherein said plurality of qualifying quantifiers comprises at least one of “always”, “except few exceptions”, “usually”, “occasionally” and “rarely”.

14. The method as claimed in claim 8, wherein said plurality of qualifying quantifiers comprises at least one of “all”, “almost all”, “most” and “few”.

15. The method as claimed in claim 8, wherein said plurality of elements to rate is selected from the group consisting of: working skills, working knowledge, survey data and academic knowledge.

16. The method as claimed in claim 11, further comprising removing at least one of the plurality of generated rating levels.

17. The method as claimed in claim 16, wherein said removing is performed by said person evaluating said person to evaluate.

18. A rating scale to be used in an evaluation form, said rating scale comprising:
A) a plurality of rating levels, each comprising:
B) at least one element to rate; and
C) a plurality of qualifying quantifiers, associating at least one of said qualifying quantifiers to each of said elements to rate.

19. The method as claimed in claim 18, wherein said associating of said at least one of said qualifying quantifiers to each of said elements to rate further comprises combining each of said associated plurality of elements to rate using a logical operator.

20. A computer readable memory adapted to store instructions which when executed generate a rating scale to be used in an evaluation form according to the method claimed in claim 1.

21. A computer readable memory adapted to store instructions which when executed generate the method as claimed in claim 8.
